(19) United States
(12) Patent Application Publication
(10) Pub. No.: US 2009/0070081 A1
(43) Pub. Date: Mar. 12, 2009

(54) PREDICTIVE MODELING IN A GAMING SYSTEM

(75) Inventors: Javier A. Saenz, Reno, NV (US); Daniel G. Carlson, Henderson, NV (US); Brian V. Gress, Henderson, NV (US); Nicholas T. Van Dyk, Henderson, NV (US)

Correspondence Address: Weaver Austin Villeneuve & Sampson LLP - IGT;Attn: IGT, P.O. Box 70250, Oakland, CA, 94612-0250, US

(73) Assignee: IGT

(21) Appl. No.: 12/205,646

(22) Filed: Sep. 5, 2008

Related U.S. Application Data
(60) Provisional application No. 60/970,412, filed on Sep. 6, 2007.

(51) Int. Cl. G06F 17/10; G06F 17/18

(52) U.S. Cl. 703/2; 702/181

(57) ABSTRACT

Methods and systems for performing comprehensive predictive analysis and modeling in a wager gaming environment are provided. Statistical calculations for deriving predictive values for a patron behavior in a casino or gaming environment may include various criteria, including but not limited to wager gaming activities, resort/hotel usage, dining/meals, non-gaming point of sale transactions, entertainment expenditures, coupon/prize redemption, “comps” provided, etc. In some implementations, a plurality of predictive models may be used. One or more criteria may be used to evaluate and/or rank the predictive models. For example, such an evaluation and/or ranking may be based, at least in part, on a correlation coefficient or a function thereof. In some such implementations, an evaluation and/or ranking may be based, at least in part, on a comparison of the coefficient of determination, R², corresponding to each predictive model.

### CROSS-REFERENCE TO RELATED APPLICATION

This application claims priority to U.S. Provisional Patent Application No. 60/970,412 (attorney docket number IGT1P456P/P-1247 PROV), entitled “Predictive Modeling of Gaming Machine Customers' Play” and filed on Sep. 6, 2007, which is hereby incorporated by reference for all purposes.

### BACKGROUND OF THE INVENTION

Gaming systems have developed over time to improve casino productivity, facilitate adherence to regulations, and settle differences and issues with players. For example, gaming systems may be able to handle real-time auditing, investigation, and examination of player and casino data. Gaming systems generally focus on reporting and patron and asset management. They may be designed for voluminous numbers of write operations to record many activities taking place in a casino environment, possibly including gaming and non-gaming activities.

The transactional systems (or source systems) running gaming and gaming-related operations have typically been Online Transaction Processing (OTLP)-based systems, such as, relational database systems, with highly normalized tables for recording and storing the huge amounts of gaming data generated constantly in casinos. Such systems are well-suited for performing real-time queries without interfering with casino floor operations. One aspect of the gaming environment is that it is highly sensitive and guarded against crashes, slow downs, or any type of glitch that may disrupt gaming by patrons. Because of the configuration, arrangement, and other technical features of transactional systems, they may not be optimized or, in some cases, may even be technically incapable of, providing some types of analytics and/or related applications. If the transactional system were used for such things, it could impact performance on the floor significantly because of the size of the queries. Such transactional systems may not be adequate or suitable for some applications.

### SUMMARY OF THE INVENTION

Methods and systems for performing comprehensive predictive analysis and modeling in a wager gaming environment are provided. Statistical calculations for deriving predictive values for a patron behavior in a casino or gaming environment may include various criteria, including but not limited to wager gaming activities, resort/hotel usage, dining/meals, non-gaming point of sale (POS) transactions, entertainment expenditures, coupon/prize redemption, “comps” provided, etc. Similar statistical calculations may also be made for deriving predictive value relating to gaming machine performance. The predictive analysis and modeling may be applied to other aspects of the gaming environment, such as gaming tables and to patrons who do not engage in wager game play but perform other financial transactions in a casino/resort/hotel environment.

In some implementations, a plurality of predictive models may be used. One or more criteria may be used to evaluate and/or rank the predictive models. For example, such an evaluation and/or ranking may be based, at least in part, on a correlation coefficient or a function thereof. In some such implementations, an evaluation and/or ranking may be based, at least in part, on a comparison of the coefficient of determination, R², corresponding to each predictive model.

Some embodiments of the invention provide an apparatus that includes an input device and a logic system. The input device may be configured for receiving input from a user regarding a desired predictive model type. The logic system, which includes at least one logic device (such as a processor, a programmable logic device, etc.) may be configured to do the following: obtain observed casino patron data from a memory, the observed casino patron data relating to the desired predictive model type; execute a plurality of predictive models of the desired predictive model type, based at least in part on the observed casino patron data; evaluate predictive model results for each of the plurality of predictive models according to predetermined criteria; and select predictive model results according to the predetermined criteria.

The logic system may be configured to determine a coefficient of determination for each of the plurality of predictive models. The logic system may be further configured to evaluate the predictive model results according to the coefficient of determination for each of the plurality of predictive models.

The desired predictive model type may pertain to an estimated theoretical value of a patron to a casino. The estimated theoretical value may comprise the estimated theoretical value of the patron during the patron's next visit to the casino and/or the estimated theoretical value of the patron to the casino during a predetermined period of time.

The desired predictive model type may involve a prediction of a period of time until a patron's next visit to a casino. Alternatively, or additionally, the desired predictive model type may involve a prediction of a patron's likelihood of redeeming an offer.

The apparatus may also include a network interface. The logic system may be configured to obtain the observed casino patron data from a data warehouse via the network interface. The logic system may be configured to obtain the patron data from a snowflake-shaped schema, a star-shaped schema or a cube.

The apparatus may also be configured to use the predictive model results as input for a marketing campaign. For example, the predictive model results could be used to identify people to whom a particular marketing campaign, a particular offer, etc., should be directed. For example, one or more measures of a patron's estimated theoretical value of the patron to the casino may be used as a basis for selecting people to whom such a marketing campaign, a offer, etc., should be directed. Other factors, such as patron preference data (e.g., wager gaming preference data, hotel preference data, food preference data, beverage preference data and/or entertainment preference data), may also be used as a basis for such a determination.

Some methods provided herein include the following steps: receiving input from a user regarding a desired predictive model type; obtaining observed casino patron data relating to the desired predictive model type; executing a plurality of predictive models of the desired predictive model type, based at least in part on the observed casino patron data; evaluating predictive model results for each of the plurality of predictive models according to predetermined criteria; and selecting predictive model results according to the predetermined criteria.

The method may involve determining a coefficient of determination for each of the plurality of predictive models. The evaluating may comprise evaluating the predictive model results according to the coefficient of determination for each of the plurality of predictive models.

The desired predictive model type may pertain to an estimated theoretical value of a patron to a casino. The estimated theoretical value may comprise, e.g., the estimated theoretical value of the patron during the patron's next visit to the casino and/or the estimated theoretical value of the patron to the casino during a predetermined period of time. The desired predictive model type may involve a prediction of a period of time until a patron's next visit to a casino and/or a prediction of a patron's likelihood of redeeming an offer.

The method may also include the step of using the predictive model results as input for a marketing campaign. For example, the predictive model results could be used to identify people to whom a particular marketing campaign, a particular offer, etc., should be directed. For example, one or more measures of a patron's estimated theoretical value of the patron to the casino may be used as a basis for selecting people to whom such a marketing campaign, a offer, etc., should be directed. Other factors, such as patron preference data (e.g., wager gaming preference data, hotel preference data, food preference data, beverage preference data and/or entertainment preference data), may also be used as a basis for such a determination.

The obtaining process may involve obtaining the patron data from a snowflake-shaped schema, a star-shaped schema or a cube. In some implementations, the obtaining process may involve obtaining the patron data from a data warehouse.

Alternative methods provided herein include the following steps: receiving input from a user regarding a desired predictive model type, wherein the desired predictive model type pertains to an estimated theoretical value of a patron to a casino; obtaining observed casino patron data relating to the desired predictive model type; executing a plurality of predictive models of the desired predictive model type to produce predictive model results, based at least in part on the observed casino patron data; determining a coefficient of determination for each of the plurality of predictive models; producing an evaluation of the predictive model results according to the coefficient of determination for each of the plurality of predictive models; and selecting predictive model results according to the evaluation. The method may also involve using the predictive model results as input for a marketing campaign.

The steps of some methods of the invention may be performed, at least in part, by one or more devices in a network, such as servers, host devices, etc. Some methods may be performed, at least in part, by a logic system of a server or another such device. The logic system may include one or more logic devices such as processors, programmable logic devices, firmware, etc.

Alternative devices and/or systems of the invention include the following elements: apparatus receiving input from a user regarding a desired predictive model type, wherein the desired predictive model type pertains to an estimated theoretical value of a patron to a casino; apparatus for obtaining observed casino patron data relating to the desired predictive model type; apparatus for executing a plurality of predictive models of the desired predictive model type to produce predictive model results, based at least in part on the observed casino patron data; apparatus for determining a coefficient of determination for each of the plurality of predictive models; means for producing an evaluation of the predictive model results, at least in part according to the coefficient of determination for each of the plurality of predictive models; and apparatus for selecting predictive model results according to the evaluation.

The device and/or system may also include apparatus for using the predictive model results as input for a marketing campaign. For example, the predictive model results could be used to identify people to whom a particular marketing campaign should be directed. For example, one or more measures of a patron's estimated theoretical value of the patron to the casino may be used as a basis for selecting people to whom such a marketing campaign, a offer, etc., should be directed. Other factors, such as patron preference data (e.g., wager gaming preference data, hotel preference data, food preference data, beverage preference data and/or entertainment preference data), may also be used as a basis for such a determination.

### BRIEF DESCRIPTION OF THE DRAWINGS

FIG. 1 is a block diagram showing relevant aspects of a gaming network in accordance with one embodiment of the present invention.

FIG. 2 is a block diagram showing a representational overview of data transformation among the various stages and systems in accordance with particular embodiments.

FIG. 3 is a flow diagram of one process that may be performed in creating a system in accordance with one embodiment of the present invention.

FIG. 4 is a block diagram of a data analysis system in accordance with one embodiment of the present invention.

FIG. 5 is a flow diagram of a process of transforming and transmitting data from initial staging tables to final staging tables in accordance with one embodiment of the present invention.

FIG. 6A is a flow diagram of a process for updating production schema with data in final stage tables in accordance with one embodiment of the present invention.

FIG. 6B is a block diagram of dimension tables in a production schema and in a final stage.

FIG. 7 is a block diagram of a fact table and three attribute tables.

FIG. 8 is a flow diagram of a process of merging a new player account into the production tables.

FIG. 9 is a flow diagram of a process of changing or updating a record, e.g., in the production schema.

FIG. 10 is a flow diagram of a process of predicting gaming activity in accordance with one embodiment of the present invention.

FIG. 11 represents a data structure that may be used in accordance with some aspects of the invention.

FIG. 12 illustrates a gaming network that may be used for some implementations of the invention.

FIG. 13 is a block diagram of an Arbiter and other devices that may be used for some implementations of the invention.

FIG. 14 is a diagram of a network device (e.g., a server) that may be configured according to some implementations of the invention.

### DETAILED DESCRIPTION OF SPECIFIC EMBODIMENTS

Reference will now be made in detail to specific embodiments of the invention. Examples of the specific embodiments are illustrated in the accompanying drawings. While the invention will be described in conjunction with these specific embodiments, it will be understood that it is not intended to limit the invention to such specific embodiments. On the contrary, it is intended to cover alternatives, modifications, and equivalents as may be included within the spirit and scope of the invention as defined by the appended claims. In the following description, numerous specific details are set forth in order to provide a thorough understanding of the present invention. The present invention may be practiced without some or all of these specific details. In other instances, well known process operations have not been described in detail in order not to unnecessarily obscure the present invention.

Moreover, the steps of methods shown and described herein are not necessarily performed in the order indicated. It should also be understood that the methods of the invention may include more or fewer steps than are indicated herein.

Methods and systems for performing comprehensive predictive analysis and modeling in a wager gaming environment are described in the figures. Statistical calculations for deriving predictive values for a patron behavior in a casino or gaming environment include wager gaming activities, resort/hotel usage, dining/meals, non-gaming point of sale (POS) transactions, entertainment expenditures, coupon/prize redemption, “comps” provided, among many other categories as described below. Similar statistical calculations may also be made for deriving predictive value relating to gaming machine performance. The predictive analysis and modeling may be applied to other aspects of the gaming environment, such as gaming tables. Moreover, the predictive analysis and modeling may be applied to patrons who do not engage in wager game play but perform other financial transactions in a casino/resort/hotel environment.

In one embodiment, a data warehouse stores some or all of the data needed to perform the predictive analysis. The data are stored in a manner in the data warehouse or similar repository that facilitates and optimizes the analysis, for example, as a snowflake-shaped schema, a star-shaped schema, a cube, or other structures. A star schema model is a representation of a central fact table with foreign keys (sometimes simply referred to herein as “keys”) to many dimension tables. The snowflake schema is a normalized implementation of dimensional data with keys in the primary dimension tables referencing additional dimensional data. A snowflake does not increase the dimensionality of the model as the dimensionality (or grain) is defined by the dimensional keys in the fact table.

The figures below describe the structure of a gaming data warehouse with respect to the predictive modeling and analysis performed on the gaming data as well as gaming-related and non-gaming related data. Wager gaming analysis may involve a specific type of predictive analysis which dictates the structure of the data warehouse, repository, etc. and the online analytical processing Online Transaction Processing (OTLP). Further, in one embodiment, the analysis may involve keeping disparate systems of data in synchronization. For example, a real-time transactional system and multidimensional data storage and analysis system (hereinafter “data analysis system” or “system”) may be used. Some examples of these are described below.

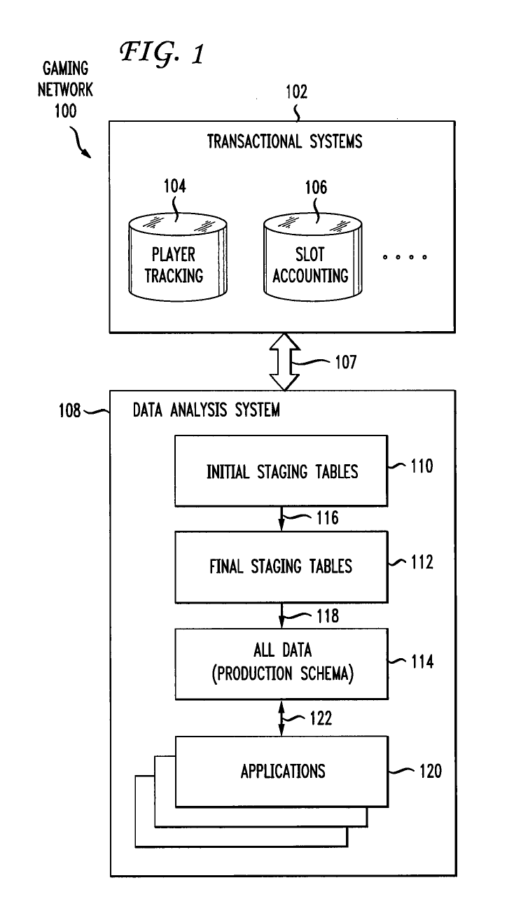

FIG. 1 is a block diagram showing relevant aspects of a gaming network in accordance with one embodiment of the present invention. A gaming network 100 has a transactional system 102 (also referred to as “source”) and a data analysis system 108 connected to each other via a network connection 107. Transactional system 102 may be described generally as a wager gaming source system, a production system that supports a gaming network. In one embodiment, transactional system 102 stores a variety of different types of data in a gaming environment, including player tracking data, gaming machine data, game table data, hotel data, point of sale data, and so on.

Data stored in transactional system 102 may be in various formats, such as flat files, back-up files, files suitable for an IBM System i™, eServer™ iSeries™ and/or AS/400™ system, in Virtual Storage Access Method (VSAM) format, as a relational database, etc. Although there are many types of data that can be stored in a transactional system, two are shown in FIG. 1 for the purpose of illustrating specific embodiments of the present invention. These are player tracking system data 104 and gaming machine or slot accounting data 106. Transactional system 102 may include various sub-systems and networks for each aspect of the gaming network. For example, data may be stored in various types of storage devices located in gaming network 100 and/or one or more other networks such as storage area networks (SANs), virtual storage area networks (VSANs), etc. These are not shown in FIG. 1, but examples of some relevant networks and features are shown and described elsewhere herein. The techniques and systems described herein may apply to other systems and data within transactional system 102 but which are not shown in FIG. 1.

Player tracking data 104 may include player demographic data and player behavior data. For example, demographic data may include player account number, one or more addresses, date of birth, zip code, and numerous other data. Player behavior data may include data on wins, losses, amount wagered, games played, game play time, play frequency, wager amount for each game, and many other fields. In some embodiments, these data items may be from a single session of play and are aggregated into a single record, also referred to as a rating. For example, a session may be defined as the game play activity from the time a player tracking card is inserted until it is retrieved and all the gaming activity by the player during that time, such as cash in, handle pulls, wins, losses, etc. Other systems, not shown in FIG. 1, may include a hotel system and cage and table systems.

Slot accounting system data 106 typically includes data on gaming machines, such as model and serial numbers, platform, versions of the software executing on it, and numerous other specifics about the machine. It may also include data relating to performance measures derived from a machine's hard and soft meters, such as cash in, cash out, credit in, and credit out, bills inserted (which may be sub-categorized according to denomination), ticket in, ticket out, and so on. Many other data items relating to specific gaming machines and all or most activity occurring on the machine may be included in slot accounting system data 106. It may be noted that the specific data items in systems 104 and 106 and their order, arrangement, configuration, type, and other specific characteristics may vary widely between gaming networks and operators.

As shown in FIG. 1, a data analysis system 108 may be in the same gaming network 100 as transactional system 102. In another embodiment, it may be in a separate network. Connection 107, for example an Ethernet connection, is used for communications between transactional system 102 to data analysis system 108. For example, connection 107 may be used to transmit data from transactional system 102 to data analysis system 108, which may store the gaming and gaming-related data in a specific format (e.g., as described below). As noted above, transactional system 102 is preferably efficient and well suited for many types of operations, such as performing real-time audits and ad hoc queries on activities in the various subsystems. For example, updating database on activities by a particular player or on a particular gaming machine can preferably be made very efficiently. Inquiries, for example, to determine whether errors were made in payouts, resolving disputes, and the like, on a gaming machine may also be made.

In one embodiment, components of gaming network 100 may be implemented, at least in part, on various servers, host devices, network devices, etc., as described below. At least some such devices may be under the control of a gaming operator, such as a casino. In some implementations, the gaming operator may also control or manage other aspects of the gaming environment, such as hotel and resort services, point of sale outlets (e.g., gift shops), dining/food services, non-gaming entertainment, and/or other patron services, including coupon/prize redemption services. In some implementations, data analysis system 108, player tracking system 104, and/or slot accounting system 106 may be implemented, at least in part, by separate servers that are under the control of a gaming operator. In another embodiment the software, firmware and data for data analysis system 108 may be distributed among servers and/or other devices within or outside of a gaming network.

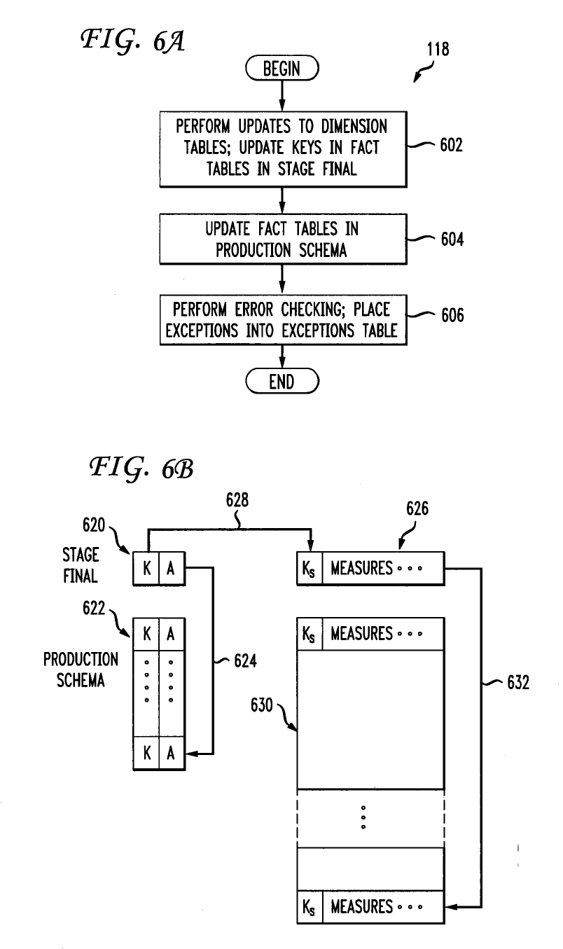

FIG. 1 shows an overview of some of the components and processes of data analysis system 108. These components and processes are introduced here and described in greater detail below. In one embodiment, data analysis system 108 is comprised of initial staging tables 110, final staging tables 112, and a production schema 114, among other components described below but not shown in FIG. 1. Data transformation process 116 performs certain transformations and operations on data before being stored in final staging tables 112. Data update and other transformations on the data occur at process 118 before being stored in production schema 114. Examples of data transformation process 116 and 118 are described below with reference to FIG. 5 and FIG. 6A, respectively.

Communication link 107 is a network connection that enables transmission of data extraction instructions from system 108 to transactional system 102 and for transmitting data from transactional system 102 based on those instructions. As described below, in some implementations the instructions may be described as persistent or “standing” instructions to retrieve the same data sets, for example, tables from the source at a frequency set by the gaming operator.

In one embodiment, final stage tables 112 and production schema 114 are implemented as a data warehouse or multidimensional database on one or more storage devices, memories, etc., that are accessible by a Structured Query Language (SQL) server or other suitable server. In other embodiments, other types of data repository constructs and paradigms may be used on various types of servers and/or other devices.

In one embodiment, the system 108 via connection 107 copies selected data from transactional systems to data analysis system 108. In the case the source side data are in a relational format, certain tables may be copied into initial staging tables. In cases where the data are in another format such as flat files, Information Management System (IMS), VSAM, and so on, the data needed may be copied and converted into an SQL format. In one embodiment, entire tables are copied into initial staging table 110. In another embodiment, portions of tables are copied, such as specific columns or segments of a flat file. However, in preferred embodiments, interference by system 108 with transactional system 102 is minimized as much as possible or at least to the extent that transactional systems, especially highly sensitive systems (such as those running the casino floor) are not affected by the data copying operation. These operations should preferably not expose the gaming operations to outages or slow downs.

The frequency of the copying may be determined by the gaming operator. In one embodiment, data are copied once a day, typically at a time when casino floor usage is low and the copying operation is unlikely to effect performance or interfere with floor operations. In other embodiments, data may be copied more often. The usefulness of having more frequent data updates, for example in predictive modeling, is described below. In another embodiment, updates to relevant data made in source 102 may be copied and reflected in the production schema in “real time” or shortly after the change is made in transactional system 102. In some embodiments wherein the data are copied once a day, all the relevant tables may be copied into the initial staging tables. In some embodiments wherein the copying is done more frequently or in real time, only certain portions of the tables may be copied, such as only those that have had changes made to them. As noted above, impact to the live transactional systems by the copying should preferably be reduced as much as possible. The transactional system should preferably not be affected by the presence of and/or interaction with the data analysis system, both of which may be operated by the gaming operator or casino.

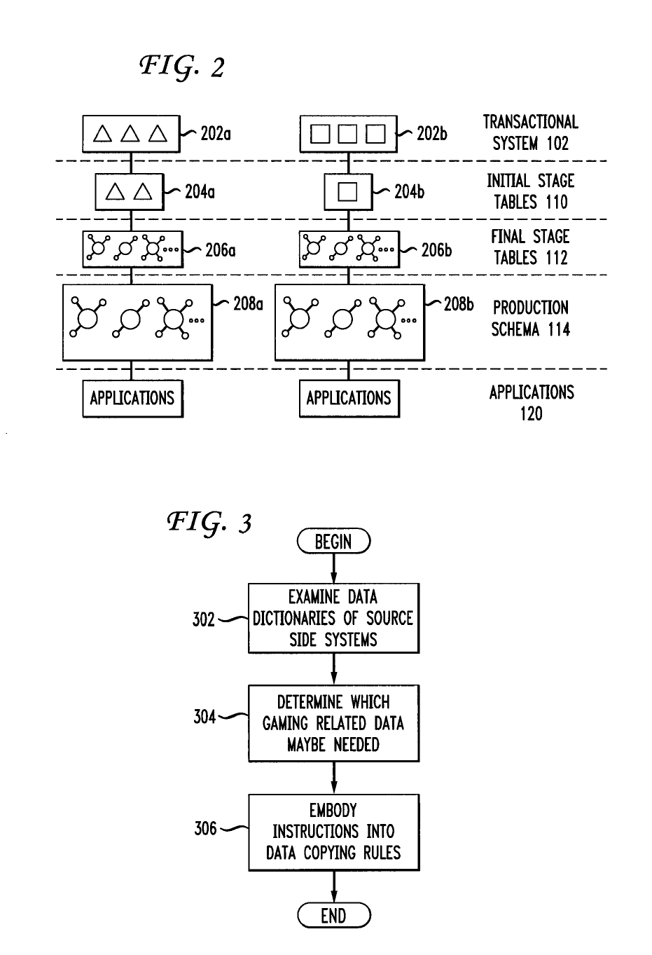

FIG. 2 is a block diagram showing a representational overview of data transformation among the various stages and systems in accordance with particular embodiments. Shown are two examples of data at the transactional system 102 level, data sets 202a and 202b. In one embodiment these are relational database tables. In other embodiments the data may be in other formats, such as IMS, VSAM, flat files, AS400 format, etc. Data set 202a has unique characteristics and therefore has been depicted in FIG. 2 by triangular shapes. Similarly, data set 202b has unique characteristics that have been depicted in FIG. 2 by rectangular shapes. At initial stage table 110 level, a subset of the tables in data sets 202a and 202b are shown as 204a and 204b. In other embodiments, data sets 202a and b may have been converted to SQL tables before being stored in initial stage tables 110. In one embodiment, minor additions may be made for internal indexing purposes, but in large part the tables are copied as they appear in the transactional systems.

In this example, data sets 204a and b have the same shape as data sets in transactional system 102. In some embodiments, it is possible that all the tables are copied from transactional system 102, but generally only a subset will be needed. For example, certain types of data (or entire tables) relating to gaming operations management and maintenance may not be needed for production schema 114 or applications 120. At the final stage tables 112 level, the data sets 206a and 206b have a different shape represented by a star schema in one embodiment. The center circle may represent a fact table and the smaller circles around it may represent dimension tables. As described below, data sets 204a and 204b go through a transformation process so that they may be represented by the shape in final stage tables 112. The shape of the data at the production schema level 114 is the same as the shape of the data in final stage tables 112, shown as data sets 208a and 208b. The representations of star schemas at the production schema 114 level are shown to be larger than those at final stage tables 112 level, in order to represent that the amount of data in data sets 208a and 208b is generally significantly more voluminous than the amount of data in final stage tables 112. The data in final stage tables 112 contain only data that has been added or updated since the last extraction from transaction system 102, whereas data in production schema 114 include all or most data collected (historical data) since data analysis system 108 went live (the size of the star schemas in tables 112 and production schema 114 are not drawn to scale). Applications 120 utilize the data stored, in one embodiment, as star schemas 208a and 208b at the production schema 114 level.

As FIG. 2 illustrates, the shape and volume of data are different at various stages in the data analysis process. The shape and volume of the data at the production schema 114 level, having numerous fact tables and associated dimension tables, allows applications 120, such as a predictive modeling application, to read gaming-related data in many different ways that would be difficult or highly inefficient if the data were stored in other shapes such as those of 202a and 202b (e.g. OTLP, relational databases, flat files, etc.). Fact and dimension tables in production schema 114 (and in final stage tables 112) are described in FIG. 7 below.

FIG. 3 is a flow diagram of one process that may be performed in creating system 108 in accordance with one embodiment of the present invention. More specifically, it is a process showing how the “instructions” or data extraction rules may be derived. At step 302 data dictionaries of the transactional systems are examined. As is known in the art, data dictionaries, for example those present in relational database systems, or similar constructs for other data formats, provide detailed information relating to all or some of the data, such as the specific fields, tables, data types, etc. in the system. The type of data stored in transactional system 102 and the organization are preferably analyzed, regardless of the specific format. In some formats (e.g. flat files, back up files, etc.), data dictionaries may not be available in which case the actual data are examined.

At step 304, it is determined (e.g., by system designers, by a device implementing a rule set, etc.) which gaming related data may be needed for populating production schema 114. At step 306 rules or instructions for which tables to copy from the various source side systems are embodied into software used by the system 108 to extract data from source 102. These rules are used by the system to copy tables or data files from the various source systems 102 to the data analysis system 108 for access by various applications. Once the rules have been created, they may be modified as needs of the gaming operator and applications change. They may also change if the data organization in source 102 changes (e.g., tables or specific fields are added or deleted).

As described below, the rules and set of transforms may vary for different transactional systems. Each proprietary transactional system may require at least some degree of customized rules and transforms since no two source systems are likely to be the same. In some embodiments, the data from source 102 may not be in a relational SQL format. As described below, when the data are copied into the initial staging tables, in such embodiments, they are converted into a relational database or SQL format. In other embodiments, this conversion may not be required and other formats may be used.

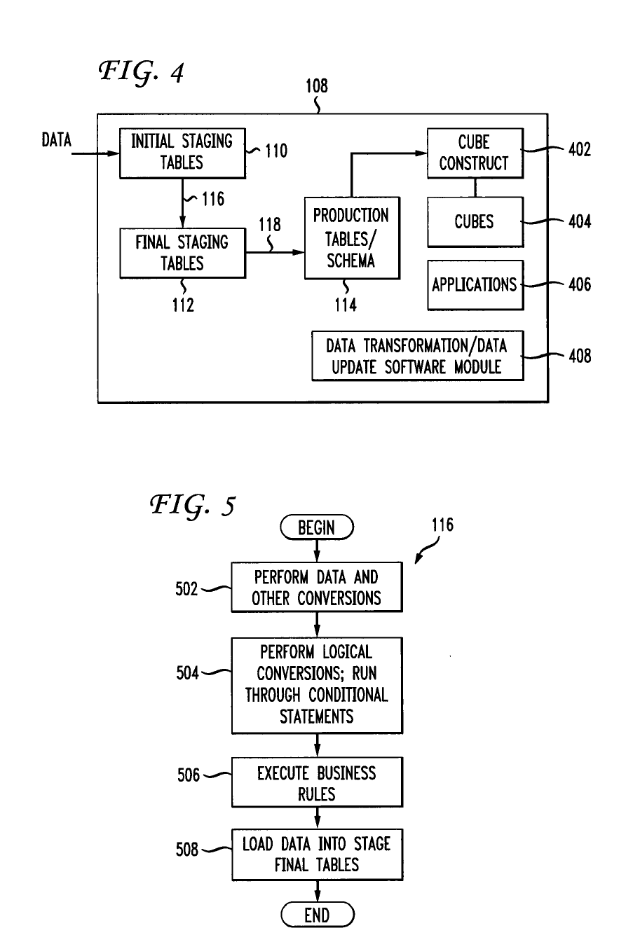

FIG. 4 is a block diagram of data analysis system 108 in accordance with one embodiment of the present invention. Data from source systems 102 are input to system 108 and are stored in initial staging tables 110. In some embodiments, the data or tables stored in initial staging tables 110 may be copies of the data extracted from transactional system 102. In some embodiments, the tables are relational database tables and SQL (or the like) may be used to operate on the data.

In one embodiment, initial staging table 110 stores relevant data from the various subsystems in source 102 in an SQL environment. As described above, the data may have been converted from another format. In other embodiments, other database formats may be used, such as IMS or a hierarchical database format. The data copied from transactional system 102 is a subset of the data in the transactional system.

In one embodiment, configuration of final staging tables 112 is the same as the configuration of tables in production schema 114. For example, if there are 30 fact tables and 50 dimension tables in production schema 114, in one embodiment the same number of fact and dimension tables and relationships among them are present in final staging tables 112. A fact table may have one or more dimension tables associated with it or keyed off of it. Data stored in a fact table may be discrete numeric data that can be aggregated and can be used, e.g., to measure performance and behavior. A dimension table may be used by more than one fact table. A fact table may or may not have any dimension tables. In some embodiments, the configuration can be described as a star schema with dimension tables branching off of a fact table at the center of the schema. However, other visual representations may also be suitable for representing production schema 114. Examples of a fact tables and dimension tables are described below.

Process 116 of preparing, transmitting, and storing data from initial staging tables 110 to final staging tables 112 is described in greater detail in FIG. 5. In some embodiments, data from initial staging, stored in SQL format and typically stored in normalized tables (in conformance with conventional relational database design), may be transformed so that the data may be stored in production schema 114, configured to make access to the data efficient for the applications.

In some embodiments, data stored in final staging tables 112 and in production schema 114 may be in an online analytical processing (OLAP) format. Such an OLAP schema is built to support data cubes, as described below. Production schema tables (fact and dimension tables) may be summarized and configured into data structures referred to in one embodiment as “marts.” For example, a gaming machine mart may have a fact table of numerical values that represent gaming machine performance measurements, also referred to as ratings, and data attributes that represent gaming machine attributes. Another example may be a player mart which has a fact table storing values relating to player behavior and a data table representing player information, such as market, tier, and so on. There may also be marts within a mart. In one embodiment, a “combo” mart contains data from other marts and links, leveraging the functionality of production schema. A mart may also have a dimension key from other marts and combines disparate types of data so analysis can be performed.

A cube builder 402 creates cubes by using a superset of possible aggregations and combinations of data in production schema 114. The cubes are stored in cubes storage module 404. In some embodiments, the cube builder application may be implemented by an SQL application server. A data value may be aggregated in as many different ways as possible or as necessary. In one embodiment, production schema 114 is a multidimensional database in which data cubes represent dimensions of data available as input to applications and for queries. For example, “wager amount” may be viewed in the dimensions of machine, patron, time, game, or other dimensions. In this example, wager amount is referred to as the measure attribute of the data cube and the other dimensions are seen as feature attributes. Additionally, a database creator may define hierarchies and levels within a dimension. An applications module 406 may be used for analytics and reporting, such as predictive modeling.

FIG. 5 is a flow diagram of a process of transforming and transmitting data from initial staging tables 110 to final staging tables 112 in accordance with one embodiment of the present invention. At step 502 software module 408 performs transformations and conversions on the data stored in initial staging tables 110. As shown in FIG. 2, this process may change the nature, configuration, and/or other characteristics of the extracted data. Once process 116 is complete, the data are in condition to be accessed and analyzed by application 406. Examples of step 502 may include changing the data type of a field, adjusting field lengths, data formatting, and so on. In some cases, a data type may be measured in a specific unit, for example a monetary denomination, that is incompatible with the denomination in the production tables. For example, an integer value may be converted to an alphanumeric value or to a string and other field-specific conversions. This step and subsequent steps in process 116 may be performed by data transformation software or logic module 408 in data analysis system 108.

At step 504, conditional logic is executed to perform further conversions that were not done at step 502. For example, a code, symbol, or term used in source 102 that may have a special meaning and/or that may only be known to source 102 may be converted to a term or variable that has meaning to, and can be used in, production schema 114. In a simple example, a data item containing the code “A” from source 102 may be converted to “Active,” a term used in data analysis system 108. At step 506 business rules and calculations are applied to the data. Roll ups and aggregations are performed on the data by software module 408. In one example, fields relating to gaming machines, such as cash in, cash out, coin in, ticket in/out, and the like are aggregated to get a “cash in” value, games played, and the like.

Thus, at the end of step 506, the relevant data from transactional system 102 (see FIG. 1) are in a configuration and format that is compatible with production schema 114. The data can now be manipulated and utilized in an efficient manner by applications 406 (see FIG. 4). For example, one significant transformation may be the de-normalization of the tables from transactional systems 102.

Returning now to FIG. 5, at step 508 the transformed data are loaded into final staging tables 112 in this example. A different set of transforms may be needed for each transactional system 102. In one embodiment, a portion of the transforms may be applicable to many different source systems from different casinos and gaming operations. However, because these systems are generally proprietary and have their own special features and characteristics, different transforms may be needed to extract and transform data from each source system.

Source system 102, comprised of various internal systems, such as player tracking, gaming machine or slot accounting, hotel, point of sale, and so on, is generally proprietary to a gaming operator or casino. There are many such systems in the gaming industry. For example, each casino company or “chain” may have developed its own internal systems or a casino may purchase or license a system from a third party developer. Each source side or transactional system 102 may be unique and have its own properties, fields, configuration, and the like that is different from the others. In one embodiment, data analysis system 108 and applications, and/or those who develop them (e.g., a third-party software developer who creates and maintains data warehouses and applications, e.g., predictive modeling applications) analyze these proprietary transactional systems. As described, tables or data files that will be used for the applications may be copied by system 108. By going through the data transformation process of FIG. 5, the functionality, applications, business rules, schema, and the like have been decoupled from the specifics of the source system. These features, such as the functionality and applications, of the data are no longer dependent on the shape of the source side systems.

As described above, the schema of tables in stage final is preferably the same as, or nearly identical to, the production schema. For the predictive modeling application(s) and other applications, data in the production schema are preferably updated to reflect changes in the transactional system. As noted, this sweep for updates and new data in the transactional system may be performed as often as desired by the gaming operator. In one embodiment, the data stored in the stage final tables are only the new data, such as entry of a new gaming machine or a new player account, or updated data for an existing entity. As described below, the production schema tables have all or most of the data collected over a longer period of time. Having the stage final tables in the same schema as the production schema facilitates transmitting the data and updating the production schema from the stage final tables. In other embodiments, the schemas do not have to be the same and other methods of updating the production schema may be used.

FIG. 6A is a flow diagram of process 118 for updating production schema 114 with data in final stage tables 112 in accordance with one embodiment of the present invention. One of the goals of data analysis system 108 is to update production schema 114 with new or updated data as efficiently as possible.

In one embodiment, production schema 114 may hold gaming data that have been collected over several years and are likely to be much larger in volume than the amount of data in stage final tables 112. Stage final tables store updated (e.g., audited or adjusted data) or, more typically, new data from gaming activity in a shorter time interval, such as one day, a half day, an hour, or shorter. Thus, in process 118 a voluminous body of data (historical data) is being updated frequently with a comparatively far smaller amount of data. This is represented visually in FIG. 2 with data sets 206a, 206b and data sets 208a, 208b (not to scale). Furthermore, two types of tables are being updated: dimension tables and fact tables, each of which may have different characteristics while sharing keys, as described below.

In one embodiment, updates to the dimension tables in production schema 114 are made first at step 602. Referring to FIG. 6B, in this example a dimension table 620 in stage final has a key column, K, and one or more attributes, A. As noted elsewhere herein, a key may be used to link one table to another, e.g., to link a central fact table to multiple dimension tables. Stored in table 620 are a new record and an updated record of an existing record (neither are shown). Corresponding dimension table 622 in production schema 114 is shown with key column K and attributes A.

At step 602 of FIG. 6A, the new record is inserted into dimension table 622 and an existing record is replaced with the updated record. In both cases, software module 408 (see FIG. 4) may check whether a record exists in dimension table 622. This process is shown by arrow 624.

In some embodiments, the number of records in a dimension table 622 may be smaller, possibly orders of magnitude smaller, than the number of records in a production schema fact table (described below), which stores actual measures and numerical data of all gaming and gaming-related activity. Thus, it may be significantly more efficient to first update the keys and attributes in dimension table 622 rather than updating fact tables first, which may be more time consuming even if an efficient index is used. By updating the production schema dimension table 622 first, the key portion of the updates are also made to a fact table 626 in stage final 112, as shown by arrow 628. Fact table 626 has one or more keys (Ks) and measures (numerical data).

At step 604, in this example a fact table 630 in production schema 114 is updated with the updated/new fact table records in table 626 in final stage tables 112. One of the keys in fact table 626 (and 630) may correspond to K in table 620 (and 622). Other keys in table 626 may also have dimension tables (not shown). Here, the keys in fact table 626 (while still in stage final 112) have already been updated in step 602 by table 620 and other dimension tables corresponding to the other keys in table 626. By having the keys fact table 626 updated while in stage final, updating and adding records to fact table 630, as shown by arrow 632, in production schema 114 is greatly facilitated because keys, Ks, have already been updated and assigned in stage final. This process avoids having to search potentially very large fact tables (as represented visually in FIG. 6B) in production schema 114 to perform updates. Thus, at step 604 new records are appended to the end of table 644 and existing records are replaced with updated records.

At step 606 the system performs error checking and places errors or exception data into an exceptions table. This process prevents corrupt data from being entered into production schema 114. For example, dimension records that are not assigned to a fact table may be stored in an exception table. In another example, if a received field is expected to be non-null but a null field is actually received, the field may be placed in an exceptions table. Data from the exceptions table may be used when running an error report to examine why particular fact records were not assigned a dimensions key.

As noted above, fact tables may have different features and characteristics from dimension tables. As shown in FIG. 2, a fact table (the center circle in levels 112 and 114) may have one or more dimension tables (smaller circles) linked to it. In some embodiments, dimension tables may be shared by different tables. Fact tables can store numeric data or measures that may, for example, imply performance or behavior. The data can normally be aggregated or “rolled up” and may often be discrete data. In the gaming context, many fact tables have a large number of rows representing a wide variety of gaming variables, such as rating. It is generally preferable to keep fact tables narrow, that is, having columns that contain short, simple discrete data items, such as numbers, dollar values, and the like.

Preferably, a fact table also has one or more keys. In one embodiment, a key in a fact table is selected and exists because it is for a dimension that the gaming operator is interested in tracking, analyzing, and/or viewing, possibly from different perspectives.

A few illustrations of fact tables and the keys and measures within those tables are provided herein. One example set forth below is a slot event fact table.

| | | | Allow |
|---|---|---|---|
| Column Name | Data Type | Length | Nulls? |
| EVENT_KEY | Int | 4 | N |
| DATE_KEY | Int | 4 | N |
| SHIFT_KEY | Int | 4 | N |
| LOCATION_KEY | Int | 4 | N |
| EMPLOYEE_KEY | Int | 4 | N |
| TIME_KEY | Int | 4 | N |
| PROPERTY_KEY | Tinyint | 1 | Y |
| Property_id | Tinyint | 1 | N |
| Event_Machine_Numb | Int | 4 | Y |
| Event_Transaction_Numb | Varchar | 50 | Y |
| Event_Record_Date | Datetime | 8 | Y |
| Event_Record_Time | Datetime | 8 | Y |
| Event_Event_Class | Varchar | 4 | Y |
| Event_License | Varchar | 8 | Y |
| Event_Card_Number | Varchar | 16 | Y |
| Event_Progressive_Size | Int | 4 | Y |
| Event_Ticket_Identifier | Int | 4 | Y |
| Event_Patron_Number | Int | 4 | Y |
| Event_Meter_2 | Numeric | 9 | Y |
| Event_Meter_6 | Numeric | 9 | Y |
| Event_Meter_7 | Numeric | 9 | Y |
| Event_Meter_8 | Numeric | 9 | Y |
| Event_Meter_10 | Numeric | 9 | Y |
| Event_Meter_27 | Numeric | 9 | Y |
| Event_Meter_28 | Numeric | 9 | Y |
| Event_Meter_29 | Numeric | 9 | Y |

In this example, the slot event fact table includes multiple keys, including an EVENT KEY, DATE KEY, and MACHINE TYPE KEY, and so on. Accordingly, the slot event fact table may be linked to various dimension tables via these keys. Dimension tables contain attributes of a particular key or “dimension” that may be of interest, e.g., to a gaming operator. In some embodiments, a dimension table may be de-normalized and the attribute data contained therein can be aggregated by system 108 or by other applications.

A dimension table may have one key, for example DATE_KEY or EVENT_KEY, that exists in one or more fact tables. The key may have various attributes that represent the columns in the dimension table, such as time, day, month, year, and so on. In some implementations, these attributes are not contained in the fact tables, but rather are broken out and stored in the dimension key. In this manner, attributes of a key are written once in the dimension table and may be analyzed, sliced, leveled, and manipulated in various ways. In contrast to the data stored in fact tables, they are not intended for measuring. Most of the columns in a dimension table are of attributes of the record that make the record unique.

For example, a slot event dimension table may include an EVENT_KEY. The slot event dimension table may include attributes such as Event_Description, Event_Group_Number, Post_Event_Flag, Record_Date and/or other attributes.

In another example, a player account dimension table may have as a key PLAYER_ACCT_NUMBER and as attributes, address, host name, zip code, player tier, and so on. These attributes can be used in queries and reports in various configurations and combinations. For both fact and dimension tables, the motivation to store particular gaming data and have certain keys or attributes may stem from the requirements of an application, such as the predictive modeling application.

Each fact table has a certain grain or, what may also be described as a least common denominator, represented by a record in the table. That grain may be a single transaction at a retail store, a player session or rating, a day, a gaming machine, a particular game, a coupon redemption, and so on. There are many examples in the wager gaming and casino/resort context. The grain of some fact tables may not be the most efficient for certain types of queries and analytics that may be desired by a gaming operator, for example, for predictive modeling.

In some embodiments, production schema 114 contains combination fact tables. The grain of a combination fact table is one for which useful or desired analytics may be performed by a gaming operator. For example, a casino resort may want to perform a predictive analysis for a patron in their player tracking system who satisfies certain criteria, e.g., a patron who gambled at the casino on gaming machines and at game tables, stayed in the hotel, went to shows and ate at restaurants in the hotel, and purchased goods at the hotel's stores (point of sale outlets). There may be individual fact tables and dimensions for each of these activities that provide a granularity that may be useful for analytics that are limited to each activity. However, the casino may want a more holistic view of the patron's activities and the disparate sets of data generated by the patron in transactional system 102 and production schema 114.

One method of providing a more complete view of a patron's behavior (or a gaming machine's performance) is to summarize and combine data from various fact tables. A combination fact table “rolls up” and aggregates data from other fact tables to provide summaries of transactions. For example, the grain of a record in a patron combination table may be one record per patron, per day, per gaming property. Such a record may provide all information on what a single patron did at one casino in one day. The patron may have played at the gaming machines five separate times (i.e., five separate inserts of his player tracking card into a gaming machine), thereby creating five separate rating records in a player activity fact table. In a combination table, these ratings may be aggregated into one rating so that the summary of the patron's gaming activity for that day may be examined from various perspectives.

This type of information may be very useful to gaming operators, especially with respect to predictive analysis, which in turn, allows an operator to more accurately target promotions, comps, incentives, and the like to patrons. Examples of combination fact tables include a patron trip combo fact table, a patron daily combo fact table, and a household daily combo fact table. There may be many other combination tables that in data analysis system 108 and may not include the one provided here as examples. Combination fact tables may share dimension tables with the non-combination fact tables or may have their own dimension tables. The keys in a combination table are keys used in the non-combination tables that the table aggregates. However, the combination table may also have its own keys that are not found in non-combination tables. Accordingly, the combination table may have its own dimension tables.

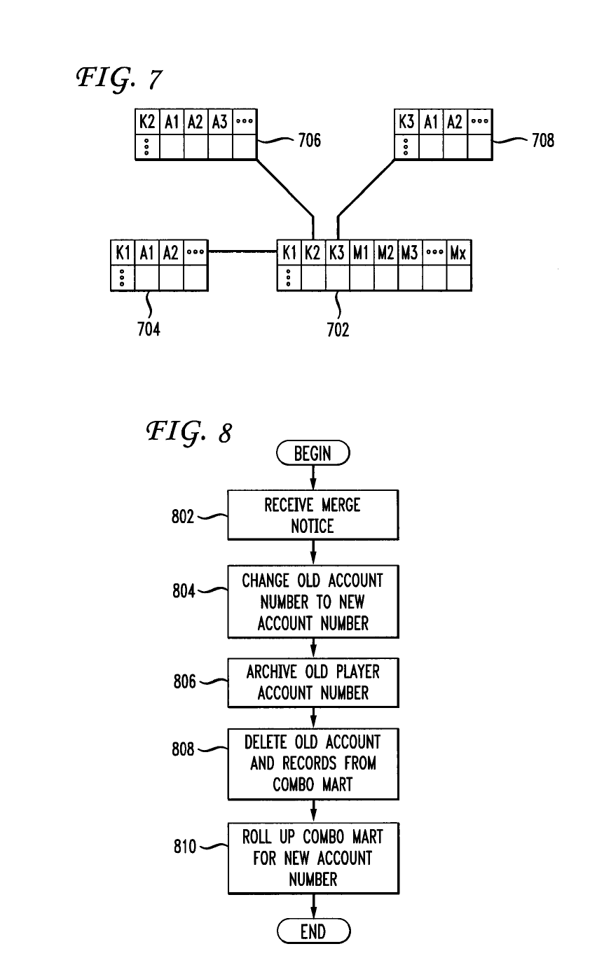

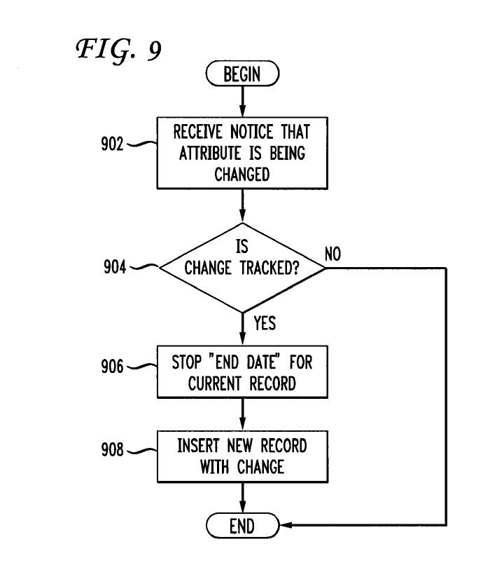

FIG. 8 is a flow diagram that provides one example of a process of merging a new player account into the production tables. At step 802 a device of the system (e.g., a server, a host device, etc.) receives a notice from the transactional system that a merge has occurred and that an update is needed to the production tables. In one embodiment, the new account number is also sent with the message. Such a message may be transmitted via communication line 107. The system adds the new account number or, as in this example, changes an old account number of the player to the new account number. At step 806 the old player account number is archived in the production schema where it will not interfere with use of the current data for predictive analysis.

In this example, in step 808 the old account and records are deleted from the combo mart. However, in alternative implementations, at least some of the old records will be retained for future reference. At step 810 the combo mart is rolled up with the new account number. During the roll up, the system will look up the new account number and data.

FIG. 9 is a flow diagram of a process for updating attribute data of production schema in accordance with some implementations of the present invention. The steps of this process may be performed, at least in part, by one or more devices (e.g., servers, host devices, storage devices, etc.) of data analysis system 108 or of another system.

In step 902, the system receives an indication that an attribute is being changed. Some changes may be tracked whereas others may not be tracked. If the change is not tracked (as determined in step 904), the process ends. However, if the change is tracked, the “end date” field (or the like) is preferably stopped for the current record. (Step 906.) A new record is inserted, with the changed attribute. (Step 908.) The process is then complete.

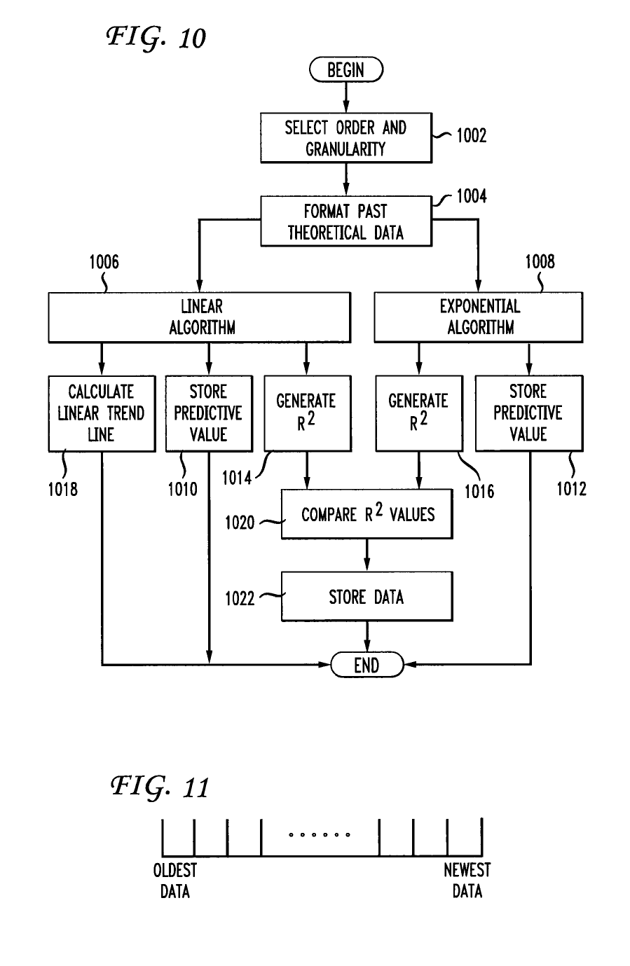

FIG. 10 is a flow diagram of a process of predicting gaming activity in accordance with one embodiment of the present invention. Predictive modeling is one example of an application that may use the data stored in production schema 114, specifically the fact and dimension tables. In one embodiment, production schema 114 holds various gaming and/or casino-related data. These data may range from gaming data relating to behavior, including wins, losses, amounts wagered, games played, and so on, to data related to different types of coupon redemptions. The data may also include gaming machine performance data, such as number of games played, amount of wins, payback percentages, and so on. As mentioned elsewhere herein, the data may also include non-gaming data such as hotel data, food and beverage data, retail data, etc.

Various types of data may be used to predict player behavior and gaming machine performance. At step 1002 the order of the data as the data are inputted to an algorithm or formula, as described below, is determined, as is the granularity of the data and the number of data values used as input. In some embodiments the number of data values may be fixed. In other embodiments, the number of data values may vary, e.g., depending on the type of prediction being made and the qualitative nature of the data.

Although there is no ideal number of data values, in some scenarios such as predicting the “next day theoretical value” of a player to a casino, described below, 24 data values may be sufficient to derive an accurate predictive value. The terms “theo,” “Theo” or the like may sometimes be used herein to mean theoretical value. It is preferable that there be at least two values used as input to the algorithms. In some embodiments, the order of the data values as they are input into the algorithms is from the oldest data to the newest data. Depending on the algorithms used, the newest data may be input first and, because of the nature of the algorithms used, the newer data may be more relevant in determining future behavior or performance. The granularity of the data values may be determined by the type of prediction being made.

At the end of step 1004 a pre-determined number of values corresponding to the type of prediction being made is appropriately configured, such as in a string or data array, for input into one or more algorithms. The prediction may be made in an ad hoc manner by the gaming operator or on an as-needed basis. For example, a segment may be created that provides all patrons with a “next day theo” greater than $700 on their next trip. This segment may use or be combined with other attributes and gaming criteria in production schema 114 (e.g., locality, age, and so on). The prediction may also be made as part of a regularly scheduled report.

At step 1006 a linear regression algorithm executes on the past actual (also referred to as theoretical or “theo”) data for the specific predictive value being calculated. Various types of linear regression algorithms may be applied, including but not limited to a linear least squares analysis, a generalized least squares analysis (which may include a weighted least squares approach as a special case), an “errors-in-variables” technique, a total least squares approach, a generalized linear model (e.g., gamma distribution, inverse Gaussian distribution, Poisson distribution, binomial distribution or multinomial distribution) or some form of “robust regression” (e.g., linear regression with Huber-White standard error estimates).

At step 1008 a non-linear regression algorithm (e.g., an exponential regression algorithm) executes using the same data. Other examples of nonlinear functions that may be used include, but are not limited to, logarithmic functions, trigonometric functions, power functions, Gaussian functions and Lorentzian curves.

In other embodiments, only one of the algorithms may be used or other known algorithms for predicting values based on historical data may be used instead of, or in addition to, the linear and/or non-linear regression algorithms. Accordingly, although only two algorithms for predictive modeling are represented in FIG. 10, any convenient number of algorithms for predictive modeling may be used according to the present invention. New algorithms for predictive modeling may be developed in the future and adopted along with, or used instead of, algorithms for predictive modeling that are in current use. The results of such predictive modeling algorithms may nonetheless be evaluated in accordance with the present invention.

In other embodiments, the data set inputted into the algorithms may be different, for example, with respect to the number of data items used as input. As described above these functions may be used to derive predictive values of future performance and behavior based on historical data. In other embodiments, a patron may have a custom or unique algorithm based on her behavior.

In some embodiments, the output of the linear regression algorithm includes a predictive value, an “R” value, and linear trend data. For example, R may be a correlation coefficient.

At step 1010 the predictive value is stored in a fact table in production schema 114. The predictive value may be a dollar value; for example, the amount a patron is predicted to spend on wager gaming during her next visit. It may also be a percentage, for example indicating the likelihood that a patron will redeem a coupon or a number of days until a next visit to the casino, and so on. In other embodiments, the predicted value is stored outside production schema 114, such as in a relational database.

Preferred implementations of the invention apply one or more criteria to evaluate and/or rank the results of predictive models. For example, such an evaluation and/or ranking may be based, at least in part, on a correlation coefficient or a function thereof. In some such implementations, an evaluation and/or ranking may be based, at least in part, on a comparison of the coefficient of determination, R², corresponding to each predictive model.

Accordingly, at step 1014 a value R² is determined from the linear algorithm. At step 1016 a value R² is determined from the exponential algorithm. In statistics, the coefficient of determination, R², is the proportion of variability in a data set that is accounted for by a statistical model. In the case of linear regression, R² is simply the square of a correlation coefficient. More generally, R² may be expressed as follows:

$${R}^{2} ≡ 1 - \frac{{SS}_{err}}{{SS}_{tot}}$$

SSₜₒₜ is the total sum of squares for the observed data and SSₑᵣᵣ is the sum of squared errors between the observed and predicted data, also called the residual sum of squares.

Significantly, the value of the coefficient of determination R² may be used to measure the strength of the predictive value produced by the respective algorithms. In some embodiments, the coefficient of determination may be normalized and/or expressed, e.g., as a number between 0 and 100. The higher the value of the coefficient of determination R², the more confidence the predictive modeling software (and/or the operator) may place in the prediction.

In one embodiment, at step 1020 the application compares the R² values corresponding to the two algorithms to determine which is greater. In another embodiment only the R values are compared. For implementations in which linear regression algorithms are being compared, this process may involve comparing the same correlation coefficient. Step 1020 is performed to select the stronger of the two predictive values produced by the algorithms. In other embodiments, there may be more algorithms used. In step 1020, the R² values of each such predictive modeling algorithm will be compared and used to determine the relative strength of the predictive values produced.

At step 1022 the stronger of the two predictive values is stored in a fact table in production schema 114. In this example, the R² value is also stored. Linear trend line data (if applicable) may also be stored in some implementations. In some embodiments, the trend may represent the normalized slope for the predicted value.

In some embodiments, a trend line is calculated. For example, a data structure of data saved at various times (e.g., such as that depicted in FIG. 11) may be referenced to calculate a trend line. The trend may be calculated in various ways, e.g., by extrapolating from the last N values, by fitting a curve to the last N values, or by computing a weighted average of the last N values, etc.

A trend line may be used to determine whether a particular value associated with a player, a gaming machine, etc., is increasing, decreasing, or remaining generally constant with respect to the value being predicted. For example, when predicting the likelihood that a patron will redeem a coupon, the trend line may indicate whether the patron has been redeeming more or fewer coupons over time. That is, it provides the gaming operator data regarding whether the patron is in an upward or downward trend. In another example, when predicting the number of days between visits to the casino, the trend line may indicate whether a patron is coming to a casino more or less frequently.

A trend line may be used to identify players on the rise or decreasing in a certain area of behavior. For example, “Predict Next Day Theo Slope of Up Greatly Increasing” may indicate that the player is greatly increasing in worth. In one embodiment, values for trend may be as follows (or the like): Up Greatly Increasing, Up Increasing, Flat, Down Decreasing, and Down Greatly Decreasing. In other embodiments, other terms and characterizations may be used to describe trend data; those mentioned are only illustrative.

The linear trend line may be stored regardless of whether the predictive value from the linear algorithm is used as the final predictive value. The trend line may still be useful in determining a trend in the player behavior or machine performance regardless of the type of predictive algorithm that is used. In some implementations, the trend line data, R² value (and/or other indicia of predictive value strength) and predictive value may all be stored in a fact table in production schema 114, along with a player or gaming machine key to uniquely identify and couple the data.

The strength of the predictive value may be categorized in various ways. For example, such categorizations may involve numerical and/or verbal indications. Some implementations involve the use of terms that are intended to be relatively more meaningful or useful to a gaming operator than a numerical value alone. In one embodiment, the categorization may be from Very High to Very Low and may be as follows: Very High—80 to 100; High—60 to 80; Neutral—40 to 60, Low—20 to 40, Very Low—0 thru 20. In other embodiments, other categorizations and labels may be used or no such categorization may be used. Preferably, the R² value (and/or other indicia of predictive value strength) be used in conjunction with a predicted value. Thus, for example, a gaming operator may use the predictive modeling application to learn that there is an 82% probability or a “Good Chance” that a player will wager $720 the next day at the casino or during her next visit to the casino.

As noted above, a predictive modeling application is one of the applications 120 that may use data in production schema 114. Various types of activity and behavior may be predicted in a gaming environment. Some that are related to player (or patron) behavior are described herein.

In some implementations, predictive modeling may be used as input for marketing campaigns. Those responsible for such campaigns may want to take one or more of such models into consideration, e.g., while building segmentation (a list of players meeting defined criteria). Various types of predictive models are described below that may be useful in this context.

Some models may be used to predict a patron's play on the next gaming day. Some such models be based (at least in part) upon data acquired during a predetermined past period of time. For example, some such models may be based upon up to a patron's past N gaming sessions (e.g., days of play) data acquired during a predetermined time. One such model, the “predict next day Theo” model, uses as input for the regression formulas data for up to 24 days of play within the past two years. In this particular model, if any of the 24 days fall outside of the two year period, those days will not be used in determining the prediction. Moreover, in this example, the player must have 3 days of play to be included on the model; otherwise the player will not be given a predicted value. However, other such models may use other time frames, other numbers of days of play (and/or gaming session units other than “days of play”), other thresholds of minimum gaming sessions for obtaining a predicted value, etc.

The purpose of other models may be to predict a patron's expenditures (including but not limited to play) with a future time interval. For example, some such models may seek to predict a patron's expenditures within the next 30 days. One such model, “predict Theo for next 30 days of play” uses a different approach from that of the “predict next day Theo” model. In the “predict Theo for next 30 days of play” model, Theo is broken into 30 day time periods and the past twenty-four time periods with play are used to determine the model. Since this model uses time periods with play, it does not predict the next 30 day time period. Instead, this model predicts the next 30 days' worth of Theo when the patron does play.

Other models may be used to predict the number of days until a player will play again. One such model uses the last N days of play as input, but instead of giving those days the total Theo win for the day, it calculates the days since the previous play. This gives the model up to N instances of lag within their play history.

Some models may be used to calculate the likelihood that an offer (e.g., a dining offer, a gaming offer, an entertainment offer, a hotel offer or a retail offer) will be redeemed, based on past redemption data. Some such models allow for players that did not redeem an offer to be modeled alongside players who are more likely to redeem. The models may or may not have thresholds for minimum previous offers. For example, some models require that for a patron to have a predicted value, the patron must have at least 3 previous periods during which offers issued to him or her. based on past redemptions. The likelihood that an offer will be redeemed may be expressed in various ways, e.g. verbally and/or numerically. In some implementations, the likelihood may be expressed as a number between 0% and 100%. The higher the number, the more likely a redemption of this offer will occur.

Some networks described herein provide methods and devices for managing one or more networked gaming establishments. Such networks may sometimes be referred to herein as server-based gaming networks, Sb™ networks, or the like. Some such gaming networks described herein allow for the convenient provisioning of networked gaming machines and other devices relevant to casino operations. Game themes may be easily and conveniently added or changed, if desired. Related software, including but not limited to player tracking software, peripheral software, etc., may be downloaded to networked gaming machines and other devices, such as kiosks, networked gaming tables, player stations, etc.

Relevant information is set forth in U.S. patent application Ser. No. 11/225,407 (Attorney Docket No. IGT1P237/P-1051), by Wolf et al., entitled “METHODS AND DEVICES FOR MANAGING GAMING NETWORKS” and filed Sep. 12, 2005, in U.S. patent application Ser. No. 10/757,609 by Nelson et al., entitled “METHODS AND APPARATUS FOR GAMING DATA DOWNLOADING” (Attorney Docket No. IGT1P213/P-657) and filed on Jan. 14, 2004, in U.S. patent application Ser. No. 10/938,293 by Benbrahim et al., entitled “METHODS AND APPARATUS FOR DATA COMMUNICATION IN A GAMING SYSTEM” (Attorney Docket No. IGT1P199/P-909) and filed on Sep. 10, 2004, in U.S. patent application Ser. No. 11/225,337 (Attorney Docket No. IGT1P185/P-1017) by Nguyen et al., filed Sep. 12, 2005 and entitled “DISTRIBUTED GAME SERVICES,” in U.S. patent application Ser. No. 11/225,408 (Attorney Docket No. IGT1P253) by Kinsley et al., entitled “METHODS AND DEVICES FOR AUTHENTICATION AND LICENSING IN A GAMING NETWORK” and filed Aug. 1, 2005, in U.S. patent application Ser. No. 11/078,966 (Attorney Docket No. IGT1P034X2/P-277 CIP2) by Nguyen et al., filed Mar. 10, 2005 and entitled “SECURED VIRTUAL NETWORK IN A GAMING ENVIRONMENT,” in U.S. patent application Ser. No. 11/173,442 (Attorney Docket No. IGT1P153/P-991) by Kinsley et al., filed Jul. 1, 2005 and entitled “METHODS AND DEVICES FOR DOWNLOADING GAMES OF CHANCE” and in U.S. patent application Ser. No. 11/810,888 (Attorney Docket No. IGT1P390/P-1200) by Graham et al., filed Jun. 6, 2007 and entitled “DATABASE QUERIES WITHIN A GAMING MACHINE,” all of which are hereby incorporated by reference in their entirety and for all purposes.

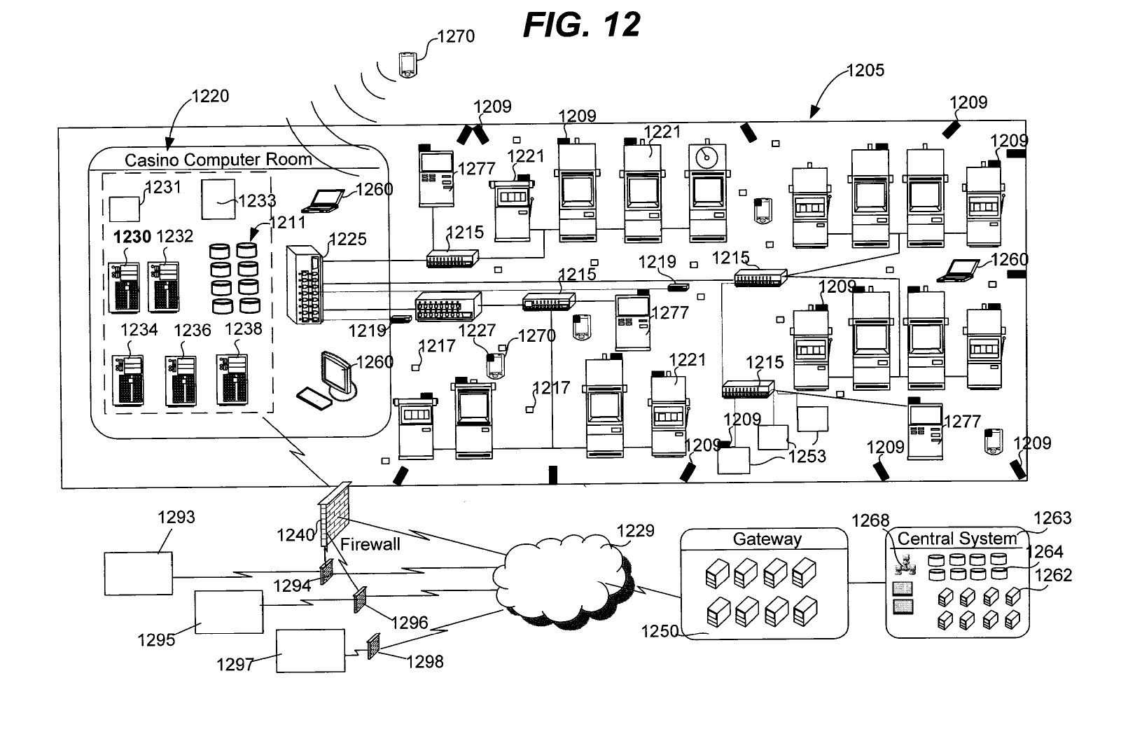

One example of an Sb™ network is depicted in FIG. 12. Those of skill in the art will realize that this architecture and the related functionality are merely examples and that the present invention encompasses many other such embodiments and methods.

Here, casino computer room 1220 and networked devices of a gaming establishment 1205 are illustrated. Gaming establishment 1205 is configured for communication with central system 1263 via gateway 1250. Gaming establishments 1293 and 1295 are also configured for communication with central system 1263.

In some implementations, gaming establishments may be configured for communication with one another. In this example, gaming establishments 1293 and 1295 are configured for communication with casino computer room 1220. Such a configuration may allow devices and/or operators in casino 1205 to communicate with and/or control devices in other casinos. In some such implementations, a server in computer room 1220 may control devices in casino 1205 and devices in other gaming establishments. Conversely, devices and/or operators in another gaming establishment may communicate with and/or control devices in casino 1205.

For example, a server of casino 1205 or central system 1263 may be provisioned with relatively more advanced software (e.g., 3-D facial recognition software) for patron identification than servers of other networked locations. Such a server may process patron identification requests from devices in casino 1205 as well as patron identification requests from devices in gaming establishments 1293 and 1295.

Here, gaming establishment 1297 is configured for communication with central system 1263, but is not configured for communication with other gaming establishments. Some gaming establishments (not shown) may not be in communication with other gaming establishments or with a central system.

Gaming establishment 1205 includes multiple gaming machines 1221, each of which is part of a bank 1210 of gaming machines 1221. In this example, gaming establishment 1205 also includes a bank of networked gaming tables 1253. However, the present invention may be implemented in gaming establishments having any number of gaming machines, gaming tables, etc. It will be appreciated that many gaming establishments include hundreds or even thousands of gaming machines 1221 and/or gaming tables 1253, not all of which are necessarily included in a bank and some of which may not be connected to a network.

Some gaming networks provide features for gaming tables that are similar to those provided for gaming machines, including but not limited to bonusing, player loyalty/player tracking and the use of cashless instruments. Relevant material is provided in U.S. patent application Ser. No. 11/154,833, entitled “CASHLESS INSTRUMENT BASED TABLE GAME PROMOTIONAL SYSTEM AND METHODOLOGY” and filed on Jun. 15, 2005 (attorney docket no. IGT1P035X3), U.S. Provisional Patent Application No. 60/858,046, entitled “AUTOMATED PLAYER DATA COLLECTION SYSTEM FOR TABLE GAME ENVIRONMENTS” and filed on Nov. 10, 2006 (attorney docket no. IGT1P061X5P), U.S. patent application Ser. No. 11/129,702, entitled “WIDE AREA TABLE GAMING MONITOR AND CONTROL SYSTEM” and filed on May 15, 2005 (attorney docket no. IGT1P115), U.S. patent application Ser. No. 11/425,998 entitled “PROGRESSIVE TABLE GAME BONUSING SYSTEMS AND METHODS”, filed Jun. 22, 2006 (attorney docket no. IGT1P238/P-1049) and U.S. patent application Ser. No. 11/225,299, entitled “UNIVERSAL CASINO BONUSING SYSTEMS AND METHODS” and filed on Sep. 12, 2005 (attorney docket no. IGT1P243), all of which are incorporated herein by reference. Accordingly, software related to such features may be provided and/or controlled, and related data may be obtained and/or provided, according to the present invention.

Some configurations can provide automated, multi-player roulette, blackjack, baccarat, and other table games. The table games may be conducted by a dealer and/or by using some form of automation, which may include an automated roulette wheel, an electronic representation of a dealer, etc. In some such implementations, devices such as cameras, radio frequency identification devices, etc., may be used to identify and/or track playing cards, chips, etc. Some of gaming tables 1253 may be configured for communication with individual player terminals (not shown), which may be configured to accept bets, present an electronic representation of a dealer, indicate game outcomes, etc.

Some gaming networks include electronically configurable tables for playing table games. U.S. patent application Ser. No. 11/517,861, entitled “CASINO DISPLAY METHODS AND DEVICES” and filed on Sep. 7, 2006 (attorney docket no. IGT1P106X2), describes some such tables and is hereby incorporated by reference. An operator may select a desired game, such as a poker game or a blackjack game, and the table will be automatically configured with geometrical patterns, text, etc., which are appropriate for the desired table game. The desired type of table game may be selected by a control on the table itself or according to instructions received from, e.g., a server or a casino manager via a network interface.

Gaming establishment 1205 also includes networked kiosks 1277. Depending on the implementation, kiosks 1277 may be used for various purposes, including but not limited to cashing out, prize redemption, redeeming points from a player loyalty program, redeeming “cashless” indicia such as bonus tickets, smart cards, etc. In some implementations, kiosks 1277 may be used for obtaining information about the gaming establishment, e.g., regarding scheduled events (such as tournaments, entertainment, etc.), regarding a patron's location, etc. Software related to such features may be provided and/or controlled, and related data may be obtained and/or provided, according to the present invention. For example, in some implementations of the invention, kiosks 1277 may be configured to receive information from a patron, e.g., by presenting graphical user interfaces.

In this example, each bank 1210 has a corresponding switch 1215, which may be a conventional bank switch in some implementations. Each switch 1215 is configured for communication with one or more devices in computer room 1220 via main network device 1225, which combines switching and routing functionality in this example. Although various communication protocols may be used, some preferred implementations use the Gaming Standards Association's G2S Message Protocol. Other implementations may use IGT's open, Ethernet-based SuperSAS® protocol, which IGT makes available for downloading without charge. Still other protocols, including but not limited to Best of Breed (“BOB”), may be used to implement various aspects of the invention. IGT has also developed a gaming-industry-specific transport layer called CASH that rides on top of TCP/IP and offers additional functionality and security.

Here, gaming establishment 1205 also includes an RFID network, implemented in part by RFID switches 1219 and multiple RFID readers 1217. An RFID network may be used, for example, to track objects (such as mobile gaming devices 1270, which include RFID tags 1227 in this example), patrons, etc., in the vicinity of gaming establishment 1205. Some examples of how an RFID network may be used in a gaming establishment are set forth in U.S. patent application Ser. No. 11/655,496, entitled “DYNAMIC CASINO TRACKING AND OPTIMIZATION” and filed on Jan. 19, 2007 (Attorney Docket No. IGT1P082C1X1/P-713 CON CIP) and in U.S. patent application Ser. No. 11/599,241, entitled “DOWNLOADING UPON THE OCCURRENCE OF PREDETERMINED EVENTS” and filed on Nov. 13, 2006 (Attorney Docket No. IGT1P118C1X1/P-303 CON CIP), all of which are hereby incorporated by reference.

As noted elsewhere herein, some implementations of the invention may involve “smart” player loyalty instruments, such as player tracking cards, which include an RFID tag. Accordingly, the location of such RFID-enabled player loyalty instruments may be tracked via the RFID network. In this example, at least some of mobile devices 1270 may include an RFID tag 1227, which includes encoded identification information for the mobile device 1270. Accordingly, the locations of such tagged mobile devices 1270 may be tracked via the RFID network in gaming establishment 1205. Other location-detection devices and systems, such as the global positioning system (“GPS”), may be used to monitor the location of people and/or devices in the vicinity of gaming establishment 1205 or elsewhere.

Various alternative network topologies can be used to implement different aspects of the invention and/or to accommodate varying numbers of networked devices. For example, gaming establishments with large numbers of gaming machines 1221 may require multiple instances of some network devices (e.g., of main network device 1225, which combines switching and routing functionality in this example) and/or the inclusion of other network devices not shown in FIG. 12. Some implementations of the invention may include one or more middleware servers disposed between kiosks 1277, RFID switches 1219 and/or bank switches 1215 and one or more devices in computer room 1220 (e.g., a corresponding server). Such middleware servers can provide various useful functions, including but not limited to the filtering and/or aggregation of data received from switches, from individual gaming machines and from other devices. Some implementations of the invention include load-balancing methods and devices for managing network traffic.

Storage devices 1211, sb™ server 1230, License Manager 1231, Arbiter 1233, servers 1232, 1234, 1236 and 1238, host device(s) 1260 and main network device 1225 are disposed within computer room 1220 of gaming establishment 1205. In practice, more or fewer devices may be used. Depending on the implementation, some such devices may reside in gaming establishment 1205 or elsewhere.

One or more devices in central system 1263 may also be configured to perform, at least in part, tasks specific to the present invention. For example, one or more servers 1262, storage devices 1264 and/or host devices 1260 of central system 1263 may be configured to implement the functions described in detail elsewhere herein. These functions may include, but are not limited to, communications with and/or collecting data from devices such as cameras 1209, RFID readers 1217, wager gaming machines 1221, gaming tables 1253, mobile devices 1270, etc., processing such data in accordance with methods described herein, predictive modeling according to methods described herein, etc.

For example, one or more of the servers of computer room 1220 may be configured with software for receiving a player's wager gaming notification parameters, determining when a wagering condition corresponds with the wager gaming notification parameters and/or providing a notification to the player when the wagering condition corresponds with the wager gaming notification parameters. Moreover, one or more of the servers may be configured to receive, process and/or provide image data from cameras 1209, to provide navigation data to patrons (e.g., to indicate the location of and/or directions to a gaming table, a wager gaming machine, etc., associated with a wager gaming notification), etc.

For example, navigation data (which may include map data, casino layout data, camera image data, etc.) may be provided by one or more of the servers of computer room 1220 to mobile devices 1270. Some implementations of the present invention include a plurality of networked cameras 1209, which may be video cameras, smart cameras, digital still cameras, etc. In some such implementations, such cameras may provide, at least in part, real-time navigation features such as those described in U.S. patent application Ser. No. 12/106,771 (attorney docket no. IGT1P410/P-1222), entitled “Real-Time Navigation Devices, Systems and Methods,” which is incorporated herein by reference.

Other devices that may be used in connection with the present invention do not appear in FIG. 12. For example, some networks for implementing the present invention may include not only various radio frequency identification (“RFID”) readers 1217, but also RFID switches, middleware servers, etc., some of which are not depicted in FIG. 12. These features may provide various functions related to the present invention. For example, a server (or another device) may determine a location of a mobile device 1270 according to the location of an RFID reader that reads an RFID tag 1227.

The servers and other devices indicated in FIG. 12 may be configured for communication with other devices in or outside of gaming establishment 1205, such as host devices 1260, kiosks 1277 and/or mobile devices 1270, for implementing some methods described elsewhere herein. Servers (or the like) may facilitate communications with such devices, receive and store patron data, provide appropriate responses, etc., as described elsewhere herein.

Some of these servers may be configured to perform tasks relating to accounting, player loyalty, bonusing/progressives, configuration of gaming machines, etc. One or more such devices may be used to implement a casino management system, such as the IGT Advantage™ Casino System suite of applications, which provides instantaneous information that may be used for decision-making by casino managers. A Radius server and/or a DHCP server may also be configured for communication with the gaming network. Some implementations of the invention provide one or more of these servers in the form of blade servers.

Some preferred embodiments of Sb™ server 1230 and the other servers shown in FIG. 12 include (or are at least in communication with) clustered CPUs, redundant storage devices, including backup storage devices, switches, etc. Such storage devices may include a “RAID” (originally redundant array of inexpensive disks, now also known as redundant array of independent disks) array, back-up hard drives and/or tape drives, etc.

In some implementations of the invention, many of these devices (including but not limited to License Manager 1231, servers 1232, 1234, 1236 and 1238, and main network device 1225) are mounted in a single rack with sb™ server 1230. Accordingly, many or all such devices will sometimes be referenced in the aggregate as an “sb™ server.” However, in alternative implementations, one or more of these devices is in communication with sb™ server 1230 and/or other devices of the network but located elsewhere. For example, some of the devices could be mounted in separate racks within computer room 1220 or located elsewhere on the network. Moreover, it can be advantageous to store large volumes of data elsewhere via a storage area network (“SAN”).

Computer room 1220 may include one or more operator consoles or other host devices that are configured for communication with other devices within and outside of computer room 1220. Such host devices may be provided with software, hardware and/or firmware for implementing various aspects of the invention. However, such host devices need not be located within computer room 1220. Wired host devices 1260 (which are desktop and laptop computers in this example) and wireless devices 1270 (which are PDAs in this example) may be located elsewhere in gaming establishment 1205 or at a remote location.

Some embodiments of the invention include devices for implementing access control, security and/or other functions relating to the communication between different devices on the network. In this example, arbiter 1233 serves as an intermediary between different devices on the network. Arbiter 1233 may be implemented, for example, via software that is running on a server or another networked device. Some implementations of Arbiter 1233 are described in U.S. patent application Ser. No. 10/948,387, entitled “METHODS AND APPARATUS FOR NEGOTIATING COMMUNICATIONS WITHIN A GAMING NETWORK” and filed Sep. 23, 2004 (the “Arbiter Application”), which is incorporated herein by reference and for all purposes. In some preferred implementations, Arbiter 1233 is a repository for the configuration information required for communication between devices on the gaming network (and, in some implementations, devices outside the gaming network). Although Arbiter 1233 can be implemented in various ways, one exemplary implementation is discussed in the following paragraphs.

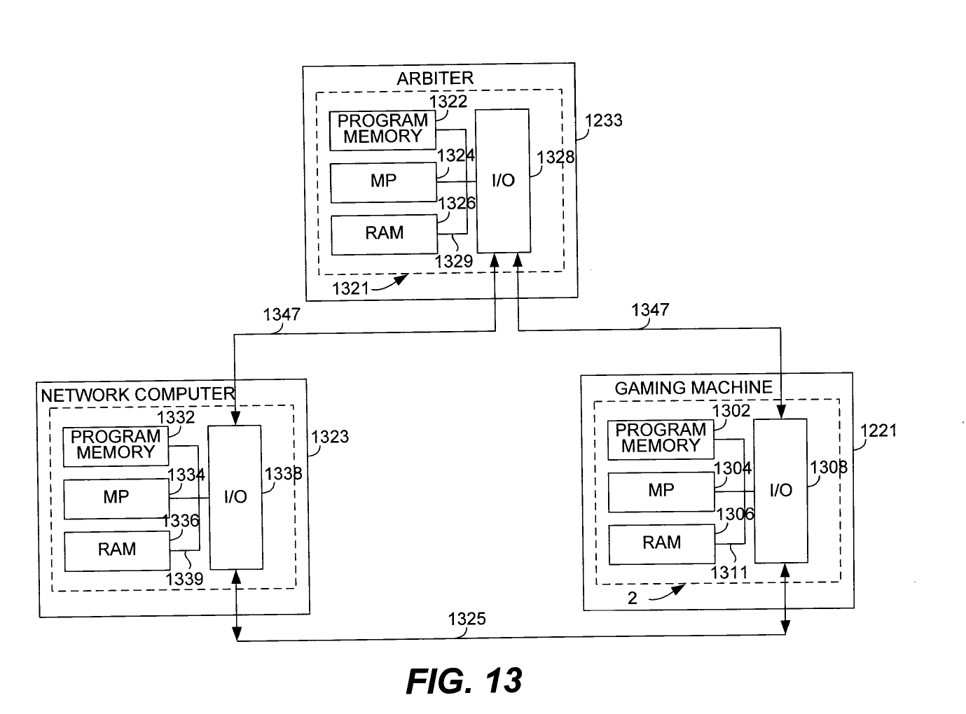

FIG. 13 is a block diagram of a simplified communication topology between gaming machine 1221, network computer 1323 and Arbiter 1233. Network computer 1323 may be, for example, a server or other device within computer room 1220 or elsewhere. Although only one gaming machine 1221, one network computer 1323 and one Arbiter 1233 are shown in FIG. 13, it should be understood that the following examples may be applicable to different types of networked devices in addition to gaming machine 1221 and network computer 1323, and may include different numbers of network computers 1323, Arbiters 1233 and gaming machines 1221. For example, a single Arbiter 1233 may be used for secure communications among a plurality of network computers 1323 and tens, hundreds or thousands of gaming machines 1221. Likewise, multiple Arbiters 1233 may be utilized for improved performance and other scalability factors.

Referring to FIG. 13, the Arbiter 1233 may include an arbiter controller 1321 that may comprise a program memory 1322, a microcontroller or microprocessor (MP) 1324, a random-access memory (RAM) 1326 and an input/output (I/O) circuit 1328, all of which may be interconnected via an address/data bus 1329. The network computer 1323 may also include a controller 1331 that may comprise a program memory 1332, a microcontroller or microprocessor (MP) 1334, a random-access memory (RAM) 1336 and an input/output (I/O) circuit 1338, all of which may be interconnected via an address/data bus 1339. It should be appreciated that although the Arbiter 1233 and the network computer 1323 are each shown with only one microprocessor 1324, 1334, the controllers 1321, 1331 may each include multiple microprocessors 1324, 1334. Similarly, the memory of the controllers 1321, 1331 may include multiple RAMs 1326, 1336 and multiple program memories 1322, 1332. Although the I/O circuits 1328, 1338 are each shown as a single block, it should be appreciated that the I/O circuits 1328, 1338 may include a number of different types of I/O circuits. The RAMs 1324, 1334 and program memories 1322, 1332 may be implemented as semiconductor memories, magnetically readable memories, and/or optically readable memories, for example.

Although the program memories 1322, 1332 are shown in FIG. 13 as read-only memories (ROM) 1322, 1332, the program memories of the controllers 1321, 1331 may be a read/write or alterable memory, such as a hard disk. In the event a hard disk is used as a program memory, the address/data buses 1329, 1339 shown schematically in FIG. 13 may each comprise multiple address/data buses, which may be of different types, and there may be an I/O circuit disposed between the address/data buses.

As shown in FIG. 13, the gaming machine 1221 may be operatively coupled to the network computer 1323 via the data link 1325. The gaming machine 1221 may also be operatively coupled to the Arbiter 1233 via the data link 1349, and the network computer 1323 may likewise be operatively coupled to the Arbiter 1233 via the data link 1347.

Communications between the gaming machine 1221 and the network computer 1323 may involve different information types of varying levels of sensitivity resulting in varying levels of encryption techniques depending on the sensitivity of the information. For example, communications such as drink orders and statistical information may be considered less sensitive. A drink order or statistical information may remain encrypted, although with moderately secure encryption techniques, such as RC4, resulting in less processing power and less time for encryption. On the other hand, financial information (e.g., account information, winnings, etc.), download information (e.g., game and/or peripheral software, licensing information, etc.) and personal information (e.g., social security number, personal preferences, etc.) may be encrypted with stronger encryption techniques such as DES or 3DES to provide increased security.

As disclosed in further detail in the Arbiter Application, the Arbiter 1233 may verify the authenticity of devices in the gaming network, including but not limited to devices sending queries and/or remote procedure calls to gaming machines. The Arbiter 1233 may receive a request for a communication session from a network device. For ease of explanation, the requesting network device may be referred to as the client, and the requested network device may be referred to as the host. The client may be any device on the network and the request may be for a communication session with any other network device. The client may specify the host, or the gaming security arbiter may select the host based on the request and based on information about the client and potential hosts. The Arbiter 1233 may provide encryption keys (session keys) for the communication session to the client via the secure communication channel. Either the host and/or the session key may be provided in response to the request, or may have been previously provided. The client may contact the host to initiate the communication session. The host may then contact the Arbiter 1233 to determine the authenticity of the client. The Arbiter 1233 may provide affirmation (or lack thereof) of the authenticity of the client to the host and provide a corresponding session key, in response to which the network devices may initiate the communication session directly with each other using the session keys to encrypt and decrypt messages.

Alternatively, upon receiving a request for a communication session, the Arbiter 1233 may contact the host regarding the request and provide corresponding session keys to both the client and the host. The Arbiter 1233 may then initiate either the client or the host to begin their communication session. In turn, the client and host may begin the communication session directly with each other using the session keys to encrypt and decrypt messages. An additional explanation of the communication request, communication response and key distribution is provided in the Arbiter Application.

Referring again to FIG. 12, the communication link(s) between casino 1205 and central system 1263 preferably have ample bandwidth and may, for example, comprise one or more T1 or T3 connections and/or satellite links having comparable bandwidth, etc. Network 1229 is the Internet in this example. However, it will be understood by those of skill in the art that network 1229 could include any one of various types of networks, such as the public switched telephone network (“PSTN”), a satellite network, a wireless network, a metro optical transport, etc. Accordingly, a variety of protocols may be used for communication on network 1229, such as Internet Protocol (“IP”), Fibre Channel (“FC”), FC over IP (“FCIP”), Internet SCSI (“iSCSI,” an IP-based standard for linking data storage devices over a network and transferring data by carrying SCSI commands over IP networks) or Dense Wavelength Division Multiplexing (“DWDM,” an optical technology used to increase bandwidth over existing fiber optic backbones).

If a host device is located in a remote location, security methods and devices (such as firewalls, authentication and/or encryption) should be deployed in order to prevent the unauthorized access of the gaming network.

Similarly, any other connection between gaming network 1205 and the outside world should only be made with trusted devices via a secure link, e.g., via a virtual private network (“VPN”) tunnel. For example, the illustrated connection between sb™ server 1230, gateway 1250 and central system 1263 (that may be used for communications involving peripheral device software downloads, etc.) is advantageously made via a VPN tunnel. Details of VPN methods that may be used with the present invention are described in the reference, “Virtual Private Networks-Technologies and Solutions,” by R. Yueh and T. Strayer, Addison-Wesley, 2001, ISBN#0-201-70209-6, which is incorporated herein by reference and for all purposes. Additionally VPNs may be implemented using a variety of protocols, such as, for example, IP Security (IPSec) Protocol, Layer 2 Tunneling Protocol, Multiprotocol Label Switching (MPLS) Protocol, etc. Details of these protocols, including RFC reports, may be obtained from the VPN Consortium, an industry trade group (http://www.vpnc.com, VPNC, Santa Cruz, Calif.).

Alternatively, a permanent virtual circuit (“PVC”) can be established to provide a dedicated and secure circuit link between two facilities, e.g., between a casino and central system 1263. A PVC is a virtual circuit established for repeated use between the same data terminals. A PVC could be provided, for example, via AT&T's Asynchronous Transfer Mode (“ATM”) switching fabric. Some implementations provide a dedicated line from an endpoint (e.g., from casino 1205) into the ATM backbone. Other implementations provide a connection over another network (e.g., the Internet) between an endpoint and the nearest device of the ATM backbone, e.g., to the nearest edge router. In some such implementations, the fixed-sized cells used in the ATM switching fabric may be encapsulated in variable sized packets (such as Internet Protocol or Ethernet packets) for transmission to and from the ATM backbone.

For security purposes, information transmitted to, on or from a gaming establishment may be encrypted. In one implementation, the information may be symmetrically encrypted using a symmetric encryption key, where the symmetric encryption key is asymmetrically encrypted using a private key. The public key may, for example, be obtained from a remote public key server. The encryption algorithm may reside in processor logic stored on the gaming machine. When a remote server receives a message containing the encrypted data, the symmetric encryption key is decrypted with a private key residing on the remote server and the symmetrically encrypted information sent from the gaming machine is decrypted using the symmetric encryption key. A different symmetric encryption key is used for each transaction where the key is randomly generated. Symmetric encryption and decryption is preferably applied to most information because symmetric encryption algorithms tend to be 100-10,000 faster than asymmetric encryption algorithms.

Some network implementations may use Trusted Network Connect (“TNC”), which is an open architecture provided by the Trusted Network Connect Sub Group (“TNC-SG”) of the Trusted Computing Group (TCG). TNC enables network operators to provide endpoint integrity at every network connection, thus enabling interoperability among multi-vendor network endpoints. Alternatively, or additionally, the Secure Internet File Transfer (“SIFT”) may be employed. SIFT allows devices to send and receive data over the Internet in a secure (128-bit encryption) method of transport.

Providing secure connections between devices in a gaming network, such as the connections between the local devices of the gaming network 1205 and central system 1263, allows for the deployment of many advantageous features. For example, a customer (e.g., an employee of a gaming establishment) may be able to log onto an account of central system 1263 to obtain the account information such as the customer's current and prior account status. Automatic updates of a customer's software may also be enabled. For example, central system 1263 may notify one or more devices in gaming establishment 1205 regarding new products and/or product updates. For example, central system 1263 may notify server (or other device) in computer room 1220 regarding new software, software updates, the status of current software licenses, etc. Alternatively, such updates could be automatically provided to a server in computer room 1220 and downloaded to networked gaming machines.

After the local server receives this information, relevant products of interest may be identified (by the server, by another device or by a human being). If an update or a new software product is desired, it can be downloaded from the central system. Similarly, a customer may choose to renew a software license via a secure connection with central system 1263, e.g., in response to a notification that the software license is required.

In addition, providing secure connections between different gaming establishments can enable alternative implementations of the invention. For example, a number of gaming establishments may be owned and/or controlled by the same entity. In such situations, having secure communications between gaming establishments makes it possible for a gaming entity to use one or more servers in a gaming establishment as an interface between central system 1263 and gaming machines in multiple gaming establishments. For example, new or updated software may be obtained by a server in one gaming establishment and distributed to gaming machines in that gaming establishment and/or other gaming establishments. A server in one gaming establishment may perform services, such as patron identification services, in response to a request from a device in another gaming establishment.

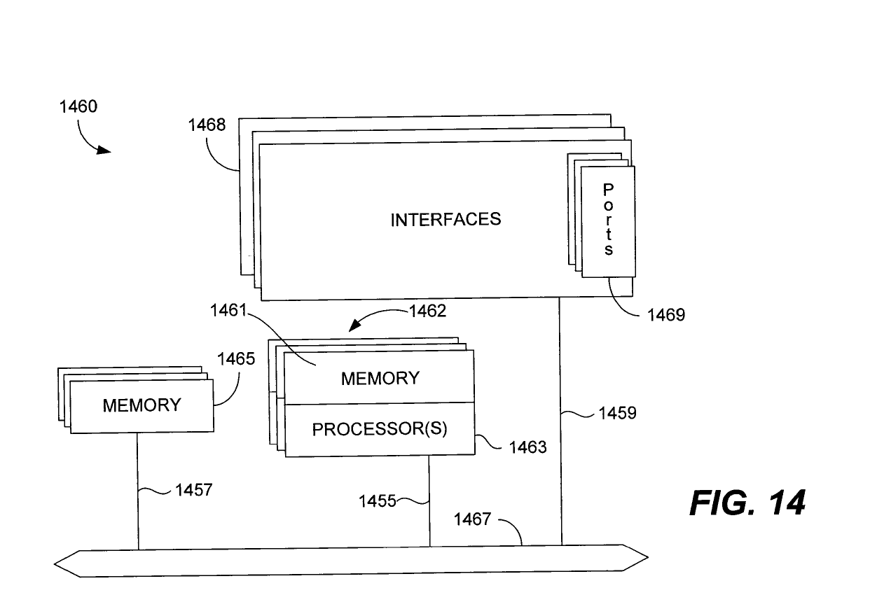

FIG. 14 illustrates an example of a network device that may be configured for implementing some methods of the present invention. Network device 1460 includes a master central processing unit (CPU) 1462, interfaces 1468, and a bus 1467 (e.g., a PCI bus). Generally, interfaces 1468 include ports 1469 appropriate for communication with the appropriate media. In some embodiments, one or more of interfaces 1468 includes at least one independent processor and, in some instances, volatile RAM. The independent processors may be, for example, ASICs or any other appropriate processors. According to some such embodiments, these independent processors perform at least some of the functions of the logic described herein. In some embodiments, one or more of interfaces 1468 control such communications-intensive tasks as encryption, decryption, compression, decompression, packetization, media control and management. By providing separate processors for the communications-intensive tasks, interfaces 1468 allow the master microprocessor 1462 efficiently to perform other functions such as routing computations, network diagnostics, security functions, etc.

The interfaces 1468 are typically provided as interface cards (sometimes referred to as “linecards”). Generally, interfaces 1468 control the sending and receiving of data packets over the network and sometimes support other peripherals used with the network device 1460. Among the interfaces that may be provided are FC interfaces, Ethernet interfaces, frame relay interfaces, cable interfaces, DSL interfaces, token ring interfaces, and the like. In addition, various very high-speed interfaces may be provided, such as fast Ethernet interfaces, Gigabit Ethernet interfaces, ATM interfaces, HSSI interfaces, POS interfaces, FDDI interfaces, ASI interfaces, DHEI interfaces and the like.

When acting under the control of appropriate software or firmware, in some implementations of the invention CPU 1462 may be responsible for implementing specific functions associated with the functions of a desired network device. According to some embodiments, CPU 1462 accomplishes all these functions under the control of software including an operating system and any appropriate applications software.

CPU 1462 may include one or more processors 1463 such as a processor from the Motorola family of microprocessors or the MIPS family of microprocessors. In an alternative embodiment, processor 1463 is specially designed hardware for controlling the operations of network device 1460. In a specific embodiment, a memory 1461 (such as non-volatile RAM and/or ROM) also forms part of CPU 1462. However, there are many different ways in which memory could be coupled to the system. Memory block 1461 may be used for a variety of purposes such as, for example, caching and/or storing data, programming instructions, etc.

Regardless of network device's configuration, it may employ one or more memories or memory modules (such as, for example, memory block 1465) configured to store data, program instructions for the general-purpose network operations and/or other information relating to the functionality of the techniques described herein. The program instructions may control the operation of an operating system and/or one or more applications, for example.

Because such information and program instructions may be employed to implement the systems/methods described herein, the present invention relates to machine-readable media that include program instructions, state information, etc. for performing various operations described herein. Examples of machine-readable media include, but are not limited to, magnetic media such as hard disks, floppy disks, and magnetic tape; optical media such as CD-ROM disks; magneto-optical media; and hardware devices that are specially configured to store and perform program instructions, such as read-only memory devices (ROM) and random access memory (RAM). Examples of program instructions include both machine code, such as produced by a compiler, and files containing higher-level code that may be executed by the computer using an interpreter.

Although the system shown in FIG. 14 illustrates one specific network device of the present invention, it is by no means the only network device architecture on which the present invention can be implemented. For example, an architecture having a single processor that handles communications as well as routing computations, etc. is often used. Further, other types of interfaces and media could also be used with the network device. The communication path between interfaces may be bus based (as shown in FIG. 14) or switch fabric based (such as a cross-bar).

The above-described methods, devices and materials will be familiar to those of skill in the gaming industry and/or in the computer hardware and software arts. Although many of the components and processes are described above in the singular for convenience, it will be appreciated by one of skill in the art that multiple components and repeated processes can also be used to practice the techniques of the present invention.

Although illustrative embodiments and applications of this invention are shown and described herein, many variations and modifications are possible which remain within the concept, scope, and spirit of the invention, and these variations should become clear after perusal of this application. Accordingly, the present embodiments are to be considered as illustrative and not restrictive, and the invention is not to be limited to the details given herein, but may be modified within the scope and equivalents of the appended claims.

We claim:

1. An apparatus, comprising:
an input device for receiving input from a user regarding a desired predictive model type;
a logic system comprising at least one logic device and configured to do the following:
obtain observed casino patron data from a memory, the observed casino patron data relating to the desired predictive model type;
execute a plurality of predictive models of the desired predictive model type, based at least in part on the observed casino patron data;
evaluate predictive model results for each of the plurality of predictive models according to predetermined criteria; and
select predictive model results according to the predetermined criteria.

2. The apparatus of claim 1, wherein the logic system is configured to determine a coefficient of determination for each of the plurality of predictive models and wherein the logic system evaluates the predictive model results according to the coefficient of determination for each of the plurality of predictive models.

3. The apparatus of claim 1, wherein the desired predictive model type pertains to an estimated theoretical value of a patron to a casino.

4. The apparatus of claim 1, wherein the desired predictive model type involves a prediction of a period of time until a patron's next visit to a casino.

5. The apparatus of claim 1, wherein the desired predictive model type involves a prediction of a patron's likelihood of redeeming an offer.

6. The apparatus of claim 1, further comprising a network interface, wherein the logic system is configured to obtain the observed casino patron data from a data warehouse via the network interface.

7. The apparatus of claim 1, wherein the logic system is configured to obtain the patron data from a snowflake-shaped schema, a star-shaped schema or a cube.

8. The apparatus of claim 1, wherein the logic system is further configured to use the predictive model results as input for a marketing campaign.

9. The apparatus of claim 3, wherein the estimated theoretical value comprises the estimated theoretical value of the patron during the patron's next visit to the casino.

10. The apparatus of claim 3, wherein the estimated theoretical value comprises the estimated theoretical value of the patron to the casino during a predetermined period of time.

11. A method, comprising:
receiving input from a user regarding a desired predictive model type;
obtaining observed casino patron data relating to the desired predictive model type;
executing a plurality of predictive models of the desired predictive model type, based at least in part on the observed casino patron data;
evaluating predictive model results for each of the plurality of predictive models according to predetermined criteria; and
selecting predictive model results according to the predetermined criteria.

12. The method of claim 11, further comprising determining a coefficient of determination for each of the plurality of predictive models, wherein the evaluating comprises evaluating the predictive model results according to the coefficient of determination for each of the plurality of predictive models.

13. The method of claim 11, wherein the desired predictive model type pertains to an estimated theoretical value of a patron to a casino.

14. The method of claim 11, wherein the desired predictive model type involves a prediction of a period of time until a patron's next visit to a casino.

15. The method of claim 11, wherein the desired predictive model type involves a prediction of a patron's likelihood of redeeming an offer.

16. The method of claim 11, further comprising the step of using the predictive model results as input for a marketing campaign.

17. The method of claim 11, wherein the obtaining comprises obtaining the patron data from a data warehouse.

18. The method of claim 11, wherein the obtaining comprises obtaining the patron data from a snowflake-shaped schema, a star-shaped schema or a cube.

19. The method of claim 13, wherein the estimated theoretical value comprises the estimated theoretical value of the patron during the patron's next visit to the casino.

20. The method of claim 13, wherein the estimated theoretical value comprises the estimated theoretical value of the patron to the casino during a predetermined period of time.

21. A method, comprising:
receiving input from a user regarding a desired predictive model type, wherein the desired predictive model type pertains to an estimated theoretical value of a patron to a casino;
obtaining observed casino patron data relating to the desired predictive model type;
executing a plurality of predictive models of the desired predictive model type to produce predictive model results, based at least in part on the observed casino patron data;
determining a coefficient of determination for each of the plurality of predictive models;
producing an evaluation of the predictive model results according to the coefficient of determination for each of the plurality of predictive models; and
selecting predictive model results according to the evaluation.

22. The method of claim 21, further comprising the step of using the predictive model results as input for a marketing campaign.

23. An apparatus, comprising:
means for receiving input from a user regarding a desired predictive model type, wherein the desired predictive model type pertains to an estimated theoretical value of a patron to a casino;
means for obtaining observed casino patron data relating to the desired predictive model type;
means for executing a plurality of predictive models of the desired predictive model type to produce predictive model results, based at least in part on the observed casino patron data;
means for determining a coefficient of determination for each of the plurality of predictive models;
means for producing an evaluation of the predictive model results, at least in part according to the coefficient of determination for each of the plurality of predictive models; and
means for selecting predictive model results according to the evaluation.

24. The apparatus of claim 23, further comprising means for using the predictive model results as input for a marketing campaign.
